(19) United States
(12) Patent Application Publication
(10) Pub. No.: US 2024/0224209 A1
(43) Pub. Date: Jul. 4, 2024

(54) METHOD AND DEVICE FOR UPLINK SYNCHRONIZATION OF TERMINAL IN INACTIVE STATE IN WIRELESS COMMUNICATION SYSTEM

(71) Applicant: Innovative Technology Lab Co., Ltd., Seoul (KR)

(72) Inventors: Won Seok LEE, Seoul (KR); Ki Bum KWON, Seoul (KR)

(21) Appl. No.: 17/909,460

(22) PCT Filed: Mar. 8, 2021
(86) PCT No.: PCT/KR2021/002797

§ 371 Date: Mar. 2, 2023

(30) Foreign Application Priority Data
Mar. 9, 2020 (KR) 10-2020-0029281

(51) Int. Cl. H04W 56/00; H04W 76/20; H04W 76/30

(52) U.S. Cl. CPC H04W 56/0045; H04W 56/0015; H04W 76/20; H04W 76/30

(57) ABSTRACT

The present disclosure relates to an uplink synchronization method and apparatus for a terminal in an inactive state in a wireless communication system. An uplink synchronization method of a terminal in an inactive state in a wireless communication system according to an embodiment of the present disclosure includes: receiving periodic uplink transmission resource configuration information from a base station; starting a time alignment timer (TAT) by receiving a timing advance command (TAC) from the base station; Transitioning to an inactive state by receiving a RRC (Radio Resource Control) release message including a suspend configuration from the base station; In the inactive state, when a predetermined trigger condition is satisfied, performing uplink transmission to the base station based on the periodic uplink transmission resource configuration information, wherein the predetermined trigger condition is the elapsed time since the TAT started. At least one of a time-related condition, a condition related to the time remaining until the TAT expires, a condition related to the expiration of the periodic notification area update timer, or a condition related to reception of a timing advance (TA) update command from the base station and the uplink transmission includes at least one of small data and dummy data; and receiving an additional TAC from the base station and restarting the TAT.

### TECHNICAL FIELD

The present disclosure relates to uplink synchronization in a wireless communication system, and specifically, to a method and apparatus for uplink synchronization for a terminal in an inactive state.

### BACKGROUND

3GPP (3rd Generation Partnership Project) NR (New Radio) system is a time-frequency resource unit in consideration of various scenarios, service requirements, potential system compatibility, etc. In order to meet requirements for 5G (5G) communication, various numerologies of criteria can be supported. In addition, the NR system has a poor channel environment such as high path-loss, phase-noise, and frequency offset occurring on a high carrier frequency. In order to overcome this phenomenon, transmission of a physical signal or a physical channel may be supported using a plurality of beams. Through this, the NR system can support applications such as enhanced mobile broadband (eMBB), massive Machine type communications (mMTC), and ultra-reliable and low latency communication (URLLC).

In order to optimize the mobility management of the terminal and improve power consumption efficiency in the 3GPP NR system, an inactive state of the terminal is introduced in the radio access network (RAN). For example, according to the RRC (Radio Resource Control) connection state between the network and the terminal, RRC-inactive (INACTIVE) mode may be supported in addition to the conventional RRC-connected (CONNECTED) mode and RRC-idle (IDLE) mode. The RRC-INACTIVE mode may correspond to a mode for supporting a case in which there is little or no load for a communication service required by the terminal. In the RRC-INACTIVE mode discussed so far, it is defined that the UE does not perform uplink transmission, but the need to support uplink transmission of the UE in the RRC-INACTIVE mode has recently emerged.
In this case, uplink synchronization is required for uplink transmission of the UE in the RRC-INACTIVE mode, but a specific method for this has not been prepared yet.

### DETAILED DESCRIPTION

### Technical Subject

An object of the present disclosure is to provide an uplink synchronization method and apparatus for a terminal in an inactive state in a wireless communication system.

An additional technical object of the present disclosure is to provide a method and apparatus for maintaining uplink time alignment by a terminal in an inactive state.

An additional technical object of the present disclosure is to provide a method and apparatus for providing uplink time alignment information for a terminal in an inactive state.

An additional technical object of the present disclosure is to provide an uplink synchronization method and apparatus in a cell reselection process of a terminal in an inactive state.

The technical objects to be achieved in the present disclosure are not limited to the technical objects mentioned above, and other technical objects not mentioned are clear to who those of ordinary skill in the art to which the present disclosure belongs from the description below.

### Technical Solution

An uplink synchronization method of a terminal in an inactive state in a wireless communication system according to an aspect of the present disclosure, the method comprising: receiving periodic uplink transmission resource configuration information from a base station; starting a time alignment timer (TAT) by receiving a timing advance command (TAC) from the base station; Transitioning to an inactive state by receiving a RRC (Radio Resource Control) release message including a suspend configuration from the base station; In the inactive state, when a predetermined trigger condition is satisfied, performing uplink transmission to the base station based on the periodic uplink transmission resource configuration information, wherein the predetermined trigger condition is the elapsed time since the TAT started. At least one of a time-related condition, a condition related to the time remaining until the TAT expires, a condition related to the expiration of the periodic notification area update timer, or a condition related to reception of a timing advance (TA) update command from the base station and the uplink transmission includes at least one of small data and dummy data; and receiving an additional TAC from the base station and restarting the TAT.

The features briefly summarized above with respect to the present disclosure are merely exemplary aspects of the detailed description of the present disclosure described below, and do not limit the scope of the present disclosure.

### Effect

According to the present disclosure, an uplink synchronization method and apparatus for a terminal in an inactive state in a wireless communication system may be provided.

According to the present disclosure, a method and apparatus for maintaining an uplink time alignment by a terminal in an inactive state may be provided.

According to the present disclosure, a method and apparatus for providing uplink time alignment information for a terminal in an inactive state may be provided.

According to the present disclosure, an uplink synchronization method and apparatus in a cell reselection process of a terminal in an inactive state may be provided.

The effects that can be obtained from the present disclosure are not limited to the above-mentioned effects, and other effects not mentioned are clearly understood by who those of ordinary skill in the art to which the present disclosure belongs from the description below.

### BRIEF DESCRIPTION OF THE FIGURES

FIG. 1 is a diagram for explaining a slot length to which the present disclosure can be applied.

FIG. 2 is a diagram for explaining the structure of a synchronization signal block to which the present disclosure can be applied.

FIG. 3 is a diagram for explaining the configuration of a MAC CE to which the present disclosure can be applied.

FIG. 4 is a diagram for explaining a random access procedure to which the present disclosure can be applied.

FIG. 5 is a diagram for explaining an exemplary format of a timing advance command to which the present disclosure can be applied.

FIG. 6 is a diagram for explaining an uplink downlink timing relationship to which the present disclosure can be applied.

FIG. 7 is a diagram illustrating an example of a state machine of a terminal to which the present disclosure can be applied.

FIG. 8 is a diagram for explaining an exemplary operation of connection-DRX to which the present disclosure can be applied.

FIG. 9 is a diagram for explaining uplink transmission of a configured grant method to which the present disclosure can be applied.

FIG. 10 is a diagram illustrating an example of an RRC state transition triggered by a terminal to which the present disclosure may be applied.

FIG. 11 is a diagram illustrating an example of an RRC state transition triggered by a network to which the present disclosure may be applied.

FIG. 12 is a diagram showing an example of an RNA update process to which the present disclosure can be applied.

FIG. 13 is a diagram showing an example of a periodic RNA update process to which the present disclosure can be applied.

FIG. 14 is a diagram for explaining an uplink synchronization maintenance operation of an inactive terminal to which the present disclosure can be applied.

FIG. 15 is a diagram for explaining an uplink synchronization maintenance operation of a base station for an inactive terminal to which the present disclosure can be applied.

FIG. 16 is a diagram for explaining examples of an uplink synchronization maintenance operation initiated by a terminal in an inactive state to which the present disclosure can be applied.

FIG. 17 is a diagram for explaining an example of an uplink synchronization maintenance operation for a terminal in an inactive state initiated by a base station to which the present disclosure can be applied.

FIG. 18 is a diagram for explaining an additional example of an uplink synchronization maintenance operation of a terminal in an inactive state to which the present disclosure can be applied.

FIG. 19 is a diagram for explaining an additional example of an uplink synchronization maintenance operation of a terminal in an inactive state to which the present disclosure can be applied.

FIG. 20 is a diagram for explaining an embodiment of a terminal operation to which the present disclosure can be applied.

FIG. 21 is a diagram for explaining an uplink synchronization operation of a terminal in a cell reselection process to which the present disclosure is applied.

FIG. 22 is a diagram for explaining an embodiment of operations of a terminal and a base station for uplink synchronization in a cell reselection process to which the present disclosure can be applied.

FIG. 23 is a diagram for explaining an additional embodiment of operations of a terminal and a base station for uplink synchronization in a cell reselection process to which the present disclosure can be applied.

FIG. 24 is a diagram showing the configuration of a base station apparatus and a terminal apparatus according to the present disclosure.

### BEST MODE TO CARRY OUT THE INVENTION

Hereinafter, with reference to the accompanying drawings, the embodiments of the present disclosure will be described in detail so that those of ordinary skill in the art to which the present disclosure pertains can easily implement them. However, the present disclosure may be embodied in several different forms and is not limited to the embodiments described herein.

In describing the embodiment of the present disclosure, if it is determined that a detailed description of a well-known configuration or function may obscure the gist of the present disclosure, a detailed description thereof will be omitted. And, in the drawings, parts not related to the description of the present disclosure are omitted, and similar reference numerals are attached to similar parts.

In the present disclosure, when it is said that a certain element is “connected”, “coupled” or “connected” with another element, it is not only a direct connection relationship, but also an indirect relationship where another element exists in the middle.

It can also include human connections. Also in this disclosure the terms “comprises” or “having” specify the presence of a recited feature, step, operation, element and/or component, but one or more other features, steps, operations, elements, components and/or The presence or addition of groups thereof is not excluded.

In the present disclosure, terms such as first, second, etc. are used only for the purpose of distinguishing one component from other components and are not used to limit the components, unless otherwise specified. It does not limit the order or importance of each other. Accordingly, within the scope of the present disclosure, a first component in one embodiment may be referred to as a second component in another embodiment, and similarly, a second component in one embodiment is referred to as a first component in another embodiment.

In the present disclosure, the components that are distinguished from each other are for clearly explaining each characteristic, and the components do not necessarily mean that the components are separated. That is, a plurality of components may be integrated to form one hardware or software unit, or one component may be distributed to form a plurality of hardware or software units. Accordingly, even if not specifically mentioned, such integrated or dispersed embodiments are also included in the scope of the present disclosure.

In the present disclosure, components described in various embodiments do not necessarily mean essential components, and some may be optional components. Accordingly, an embodiment composed of a subset of components described in one embodiment is also included in the scope of the present disclosure. In addition, embodiments including other components in addition to components described in various embodiments are also included in the scope of the present disclosure.

The terminology used in the present disclosure is for the description of specific embodiments and is not intended to limit the claims. As used in the description of the embodiments and in the appended claims, the singular forms are intended to include the plural forms as well, unless the context clearly dictates otherwise. Also, terms used in this disclosure “And/or” may refer to one of the related enumerations, or is meant to refer to and include any and all possible combinations of two or more of them.

The present disclosure describes a wireless communication network or a wireless communication system, and operations performed in the wireless communication network control the network and transmit or receive signals from a device (e.g., a base station) having jurisdiction over the wireless communication network. This may be done in the process of doing this, or in the process of transmitting or receiving a signal between terminals or in a terminal coupled to a corresponding wireless network.

It is obvious that various operations performed for communication with a terminal in a network consisting of a plurality of network nodes including a base station may be performed by the base station or other network nodes other than the base station. ‘Base station (BS: Base Station)’ may be replaced by terms such as fixed station, Node B, eNodeB (eNB), ng-eNB, gNodeB (gNB), access point (AP), etc. In addition, ‘terminal’ may be replaced by terms such as User Equipment (UE), Mobile Station (MS), Mobile Subscriber Station (MSS), Subscriber Station (SS), and non-AP station. can

In the present disclosure, transmitting or receiving a channel includes the meaning of transmitting or receiving information or a signal through a corresponding channel. For example, transmitting the control channel means transmitting control information or a signal through the control channel. Similarly, to transmit a data channel means to transmit data information or a signal over the data channel.

Definitions for abbreviations used in the present disclosure are as follows.

CM: Connection Management

DCI: Downlink Control Information

MAC: Medium Access Control

PBCH: Physical Broadcast Channel

PDCCH: Physical Downlink Control Channel

PDSCH: Physical Downlink Shared Channel

PUCCH: Physical Uplink Control Channel

PUSCH: Physical Uplink Shared Channel

RAN: Radio Access Network

RNA: RAN based Notification Area

RNAU: RAN based Notification Area Update

RRC: Radio Resource Control

RNTI: Radio Network Temporary Identifier

SSB: Synchronization Signal Block

TA: Timing Advance

TAC: Timing Advance Command

TAG: Timing Advance Group

TAT: Time Alignment Timer

TAU: Tracking Area Update

The 5G system may be defined as including all of the existing LTE (Long Term Evolution) series as well as the NR system. That is, the 5G system may include not only the case where the NR radio access technology is applied alone, but also the case where the LTE-based radio access technology and the NR radio access technology are applied together. In addition, the 5G sidelink technology can be said to include all of the sidelink technologies to which NR alone or LTE series and NR are applied together.

Hereinafter, the physical resource structure of the NR system will be described.

Uplink and downlink transmission and reception may be performed based on a corresponding resource grid. One resource grid may be created per antenna port and per subcarrier spacing. One resource element (RE) in the resource grid may be defined by one subcarrier and one OFDM (Orthogonal Frequency Division Multiplexing) symbol.

One resource block (Resource Block, RB) on the frequency domain may consist of 12 REs. In the time domain, one resource block may consist of one OFDM symbol. The OFDM symbol may include a cyclic prefix (CP). The CP type may include a normal CP and an extended CP.

Numerology in the NR system can be variously configured to flexibly satisfy various services and requirements in various frequency bands. Table 1 below shows examples of numerology supported by the NR system.

TABLE 1

| | | | Supported for | Supported for |
|---|---|---|---|---|
| μ | Δf = 2^{μ} · 15 [kHz] | Cyclic prefix | data | synch |
| 0 | 15 | Normal | Yes | Yes |
| 1 | 30 | Normal | Yes | Yes |
| 2 | 60 | Normal, | Yes | No |
| | | Extended | | |
| 4 | 120 | Normal | Yes | Yes |
| 5 | 240 | Normal | Yes | Yes |

Referring to Table 1, numerology may be defined based on subcarrier spacing (SCS) used in the OFDM system, CP length, and the number of OFDM symbols per slot.

For example, in Table 1, the SCS (Δf) according to the subcarrier spacing setting index (μ) is shown. In addition, when the value is 2, the extended CP may be applied, and in other cases, only the normal CP may be applied. In addition, the numerology when the value is 0, 1, 3 or 4 can be applied to the SSB (or PBCH), and the numerology when the value is 0, 1, 2, 3 can be applied to other physical channels (e.g. For example, it can be applied to the data channel).

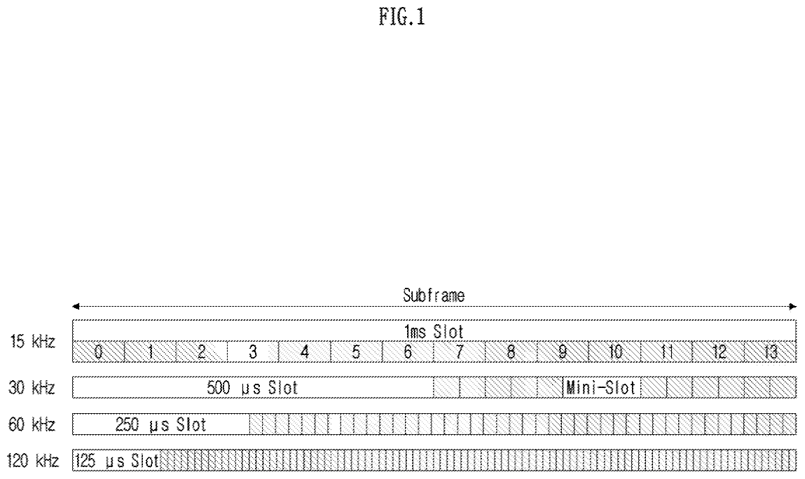

FIG. 1 is a diagram for explaining a slot length to which the present disclosure can be applied.

As in the example of FIG. 1, for each SCS configuration (μ), the number of OFDM symbols per slot, the number of slots per frame (or radio frame), the number of slots per subframe, etc are determined. For example, uplink and downlink transmission and reception may be performed based on a frame having a length of 10 ms. One frame may consist of 10 subframes having a length of 1 ms. In addition, transmission in the physical layer may be performed in units of slots, and one slot may consist of 14 OFDM symbols in the normal CP and 12 OFDM symbols in the extended CP. The number of slots per one frame or the number of slots per one subframe may vary according to the SCS configuration.

In the example of FIG. 1, when the value is 0, one subframe includes one slot in SCS of 15 kHz, one slot has a length of 1 ms, and one slot has 14 OFDM symbols Therefore, one subframe includes 14 OFDM symbols. When the μ value is 3, one subframe includes 8 slots, one slot has a length of 125 s, and one slot includes 14 OFDM symbols in SCS of 120 kHz, so one subframe contains 112 OFDM symbols.

Here, a slot may be defined as a basic time unit used to transmit basically one piece of data and control information in the NR system. One slot consists of 14 (or 12) OFDM symbols, and since the time length of one OFDM symbol varies depending on the number, the time length of one slot also varies according to the number. On the other hand, unlike the time length of the slot that varies depending on the neurology, the subframe has an absolute time length corresponding to 1 ms in the NR system, and can be used as a reference time for the length of another time interval.

In addition, a mini-slot may be defined in the NR system. The mini-slot may mean a slot having fewer OFDM symbols than the normal slot. For example, when a low delay time is required as in the URLLC service, the delay time may be reduced by using a mini-slot shorter than the normal slot. For example, the number of OFDM symbols constituting the mini-slot may be 2, 4, or 7.

Hereinafter, downlink synchronization and uplink synchronization in the NR system will be described.

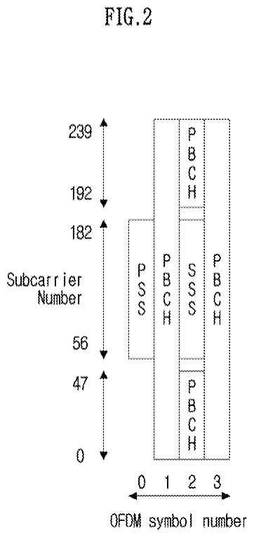

FIG. 2 is a diagram for explaining the structure of a synchronization signal block to which the present disclosure can be applied.

The synchronization signal block (SSB) may include a synchronization signal (Synchronization Signal, SS) and a physical broadcast channel (PBCH). The SS may include a Primary SS (PSS) and a Secondary SS (SSS), and the PBCH may include a PBCH DeModulation Reference Signal (DMRS) and PBCH data.

Referring to FIG. 2, one SSB may be defined as 4 OFDM symbol units in the time domain and 240 subcarriers (or REs) in the frequency domain. PSS may be transmitted in the first symbol, and SSS may be transmitted in the third symbol. The PBCH may be transmitted in the second, third, and fourth symbols. In the third symbol, the SSS may be positioned to be spaced apart from the PBCH by a guard period in 127 subcarriers in the middle, and the PBCH may be positioned in the low frequency and high frequency directions in the remaining subcarriers. In the time domain, the SSB may be transmitted based on a predetermined transmission pattern.

In the initial cell search step, the terminal detects the PSS and the SSS included in the SSB transmitted from the base station and may perform downlink synchronization with the corresponding base station. Accordingly, the terminal may receive system information, etc. transmitted from the base station through the downlink channel.

In order for the terminal to successfully perform uplink transmission to the base station, uplink synchronization is required. The terminal may attempt uplink transmission to the base station through a random access procedure, etc. even in a state where uplink synchronization is not matched, and the base station provides time alignment information (e.g., TAC) to the corresponding terminal based on the uplink signal from the terminal.

Time alignment information may be included in a random access response (Random Access Response, RAR) or MAC control element (Control Element, CE).

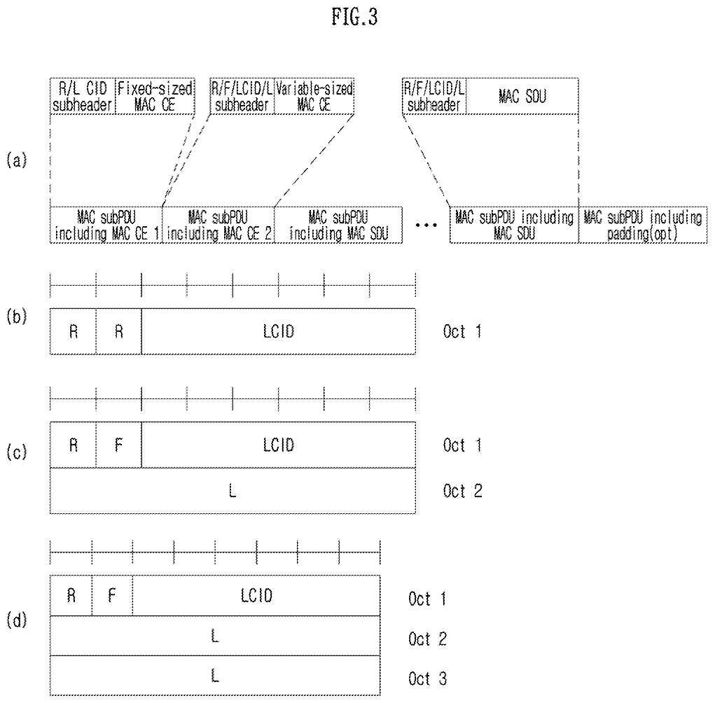

FIG. 3 is a diagram for explaining the configuration of a MAC CE to which the present disclosure can be applied.

It shows that one MAC PDU (Protocol Data Unit) is composed of one or more MAC subPDUs in FIG. 3(a). One MAC subPDU may include only a MAC subheader, include a MAC subheader and a MAC Service Data Unit (SDU), include a MAC subheader and a MAC CE, or include a MAC subheader and padding. have.

FIGS. 3 (b) to 3 (d) show exemplary formats of the MAC subheader.

FIG. 3(b) shows a MAC subheader format used in the case of a fixed length MAC CE, MAC SDU, and padding. For example, the format of the MAC subheader may be defined as 1 octet (or 8 bits) including the R and LCID fields. The 1-bit R field indicates a reserved field and its value may be 0. A 6-bit LCID (Logical Channel Identifier) field indicates a logical channel identifier field. For example, when the value of the LCID field is 62, TAC may be indicated in downlink, and UE Contention Resolution Identity may be indicated in uplink.

FIGS. 3 (c) and 3 (d) show a MAC subheader format used in the case of a variable MAC CE and MAC SDU. For example, the format of the MAC subheader may be defined with a size of 2 octets or 3 octets including R, F, LCID and L fields. The 1-octet or 2-octet L field may have a value indicating the variable length of the MAC SDU or MAC CE in octets (or bytes). The 1-bit F field may have a value indicating the size of the L field. For example, when the value of the F field is 0, it may mean that the size of the L field is 1 octet, and when the value of the F field is 1, it may mean that the size of the L field is 2 octets.

As described above, each of the LCID, L, and F fields in one MAC subheader may be included one by one.

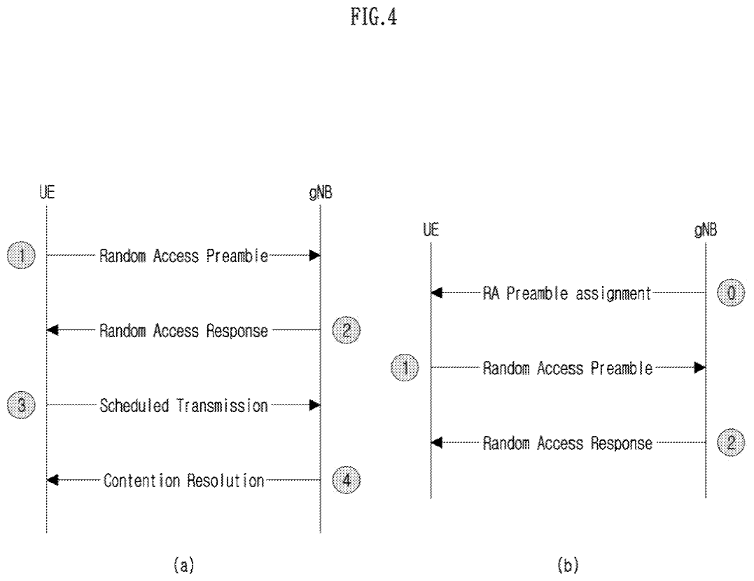

FIG. 4 is a diagram for explaining a random access procedure to which the present disclosure can be applied.

FIG. 4 (a) shows a contention based random access procedure, and FIG. 4 (b) shows a non-contention-free random access procedure.

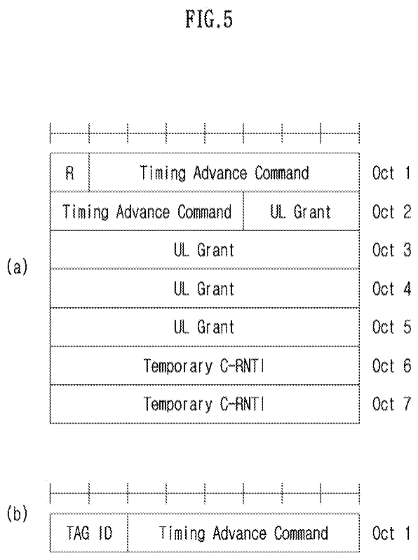

In step 1 of FIG. 4 (a), the terminal may transmit a random access preamble (or Msg1) to the base station. The preamble may be randomly selected by the UE from a set of preamble candidates indicated through information provided from the base station (e.g., system information block 1 (SIB1), system information block 2 (SIB2), or a dedicated RRC message). have. In step 2, the base station may transmit RAR (or Msg2) to the terminal. And, the RAR may include a timing advance command (TAC) and an uplink grant (UL grant) (see FIG. 5(a)). In step 3, the terminal may perform uplink transmission (or Msg3 transmission) scheduled by the UL grant provided from the base station. In step 4, the base station may transmit a contention resolution message (or Msg4) to the terminal. Through the contention resolution message, the UE may determine whether random access succeeds.

Contention-based random access may include a 4-step scheme and a 2-step scheme as shown in FIG. 4(a). For example, the two-step contention-based random access procedure consists of a step A in which the terminal transmits information corresponding to Msg1 and Msg3, and a step B in which the base station transmits information corresponding to Msg4 (and Msg2). can Unless otherwise specified in the following description, any of a four-step method or a two-step method may be applied to the contention-based random access procedure.

In step 0 of FIG. 4(b), the base station may allocate a random access preamble to the terminal. Unlike in the contention-based random access of FIG. 4(a) where the UE randomly selects a preamble from a preamble candidate set, in the non-contention random access of FIG. 4(b), the UE uses the preamble designated by the base station in step 1 can be sent to For example, when a UE in an RRC active state performs handover from a serving cell to a target cell, a random access preamble to be transmitted to the target cell may be provided from the network. In step 2, the random access procedure may be completed by the base station transmitting the RAR to the terminal.

FIG. 5 is a diagram for explaining an exemplary format of a timing advance command to which the present disclosure can be applied.

FIG. 5 (a) shows an example of a MAC RAR format, FIG. 5 (b) shows an example of a MAC CE TAC format.

Referring to FIG. 5 (a), the base station receiving the random access preamble from the terminal may generate a MAC RAR. The timing advance command (TAC) may correspond to uplink time alignment information derived based on the arrival time of the random access preamble received by the base station from the terminal. An uplink grant (UL grant) may correspond to resource scheduling information for Msg3 transmission of the terminal. Temporary cell-RNTI (Temporary C (Cell)-RNTI) may mean a temporary identifier according to the time and frequency resource location of the random access preamble. The temporary C-RNTI may be used by the UE for Msg3 transmission and retransmission, and Msg4 may be received by monitoring a cyclic redundancy code (CRC) scrambled PDCCH from the base station with the temporary C-RNTI. In addition, the MAC RAR may further include fields such as a Backoff Indicator (BI) and a Random Access Preamble Identifier (RAPID).

Referring to FIG. 5(b), the MAC CE TAC format may include a timing advance group identifier (TAG ID) field and a TAC field. The TAG ID field may include an identifier indicating the TAG, and the TAC field may include a TAC value to be applied by the UE.

The MAC entity may operate a time alignment timer (Time Alignment Timer, TAT) for each TAG in order to determine whether the time alignment between the base station and the terminal is maintained. The TAT is a timer corresponding to a length of time (or a time interval in which the TAC is assumed to be valid) during which uplink time alignment is maintained in the TAG to which the base station belongs. When the base station transmits the TAC to the terminal, the MAC entity of the corresponding terminal may start TAT for the TAG indicated by the TAG ID. If a new TAC is received during the TAT operation, the UE may restart the TAT. When the TAT expires or does not operate, the terminal may determine that the uplink time alignment with the base station is not maintained. If the uplink time alignment is not maintained, the UE cannot perform uplink transmission except for the random access preamble.

In the RRC layer, the value of TAT can be set to one of 500 ms, 750 ms, 1280 ms, 1920 ms, 2560 ms, 5120 ms, 10240 ms, and infinity through system information (e.g., SIB1).

When the UE performs a random access procedure after obtaining system information, the TAT configured as above may be used. In addition, the network may configure the TAT to the terminal through an RRC message other than the system information (e.g., an RRC connection reconfiguration message).

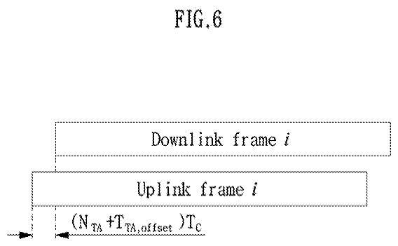

FIG. 6 is a diagram for explaining an uplink downlink timing relationship to which the present disclosure can be applied.

The basic unit of the time domain in the NR system may be T_{c}=1/(Δfₘₐₓ·N_{f}), Δfₘₐₓ=480·10³, and N_{f}=4096. Meanwhile, in LTE, the time domain basic unit may be Tₛ=1/(Δf_{ref}·N_{f,ref}), Δf_{ref}=15·10³, and N_{f,ref}=2048. A constant for the multiple relationship between the NR time base unit and the LTE time base unit may be defined as κ=Tₛ/T_{c}=64.

Referring to FIG. 6, the time structure of a frame (or radio frame) for downlink or uplink transmission may have T_{f}=1/(Δfₘₐₓ·N_{f}/100)T_{c}=10 ms. At this time, one frame is composed of 10 subframes corresponding to T_{sf}=(ΔfₘₐₓN_{f}/1000)·T_{c} time. The number of consecutive OFDM symbols per subframe may be N_{symb}^{subframe,μ}=N_{symb}^{slot}N^{slot,subframe,μ}. In addition, each frame may be divided into two half frames of the same size, half frame 1 may be composed of subframes 0-4, and half frame 2 may be composed of subframes 5-9.

Referring to FIG. 6, the NTA indicates a timing advance (TA) between the downlink (DL) and the uplink (UL). In this case, the transmission timing of the uplink transmission frame i is determined based on the downlink reception timing in the terminal based on Equation 1 below.

T_{TA}=(N_{TA}+N_{TA,offset})T_{c} [Equation 1]

In Equation 1, N_{TA,offset} may be a TA offset value generated due to a duplex mode difference or the like. Basically, in Frequency Division Duplex (FDD), N_{TA,offset} may have a value of 0, but in Time Division Duplex (TDD), it may be defined as a fixed value of N_{TA,offset} in consideration of the margin for DL-UL switching time. Also, the default values of N_{TA,offset} may be given as different values according to frequency ranges. For example, the value of N_{TA,offset} may be 25600 in the first frequency range (FR1) of less than 6 GHz, and 13792 in the second frequency range (FR2) of 6 GHz or more (e.g., 23.5 to 53.6 GHz).

N_{TA} may be determined differently according to the TAC provided through the RAR or MAC CE described with reference to FIG. 5

For example, the 12-bit TAC field provided through RAR may have a value of 0 to 3846, which may be expressed as TA. In this case, the N_{TA} may be determined according to Equation (2).

N_{TA}=T_{A}·16·64/2^{μ} [Equation 2]

For example, the 6-bit TAC field of the MAC CE format may have a value of 0 to 63, which may be expressed as TA. In this case, N_{TA} may be determined according to Equation (3). In Equation 3, N_{TA}_old may correspond to a value N_{TA} previously or currently applied by the UE, and N_{TA}_New may correspond to a value N_{TA} newly determined by the UE according to the TAC. In the case of 6-bit TAC, 64 regions (or steps) may be indicated, and 64 regions may correspond to the range of −32T_{c} to 32T_{c} in real time. That is, when the value of Tc is 0.509 ns, the time range adjusted by the 6-bit TAC for the actual frame may be −16.3 s to 16.3 s.

N_{TA}_{_{new}}=N_{TA}_{_{old}}+(T_{A}−31)·16·64/2 [Equation 3]

Hereinafter, the RRC state of the UE will be described.

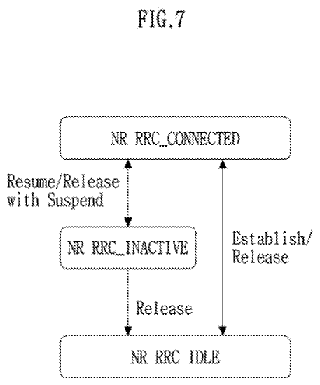

FIG. 7 is a diagram illustrating an example of a state machine of a UE to which the present disclosure can be applied.

The RRC layer may perform RRC connection control, system information broadcasting, radio bearer (RB) connection and release, mobility control, power control, and the like. The RRC state of the UE includes connected, inactive, and idle states, and the RRC state of the UE may be set or controlled by the network.

The RRC connection state means a state in which authentication and security between the UE and the network are configured, and a Signaling Radio Bearer (SRB) and a Data Radio Bearer (DRB) are activated. In the RRC connected state, the following operations may be supported.

The UE may reduce power consumption by performing a DRX operation according to a discontinuous reception (DRX) cycle set by the network.

One-to-one communication (i.e., unicast) between the base station and the UE is possible.

When carrier aggregation (CA) is supported, one or more additional secondary cells (SCells) are configured in a primary cell (PCell), so that the bandwidth available to the UE may be increased.

When dual connectivity (DC) is supported, an additional one secondary cell group (SCG) is configured in a master cell group (MCG), so that the bandwidth available to the UE may be increased.

It is possible to perform functions such as system information reception, paging message reception, control channel reception related to a scheduled data channel, channel information and status reporting, and measurement reporting (MR).

The RRC inactive state means a state in which the radio bearer is suspended, and may be transitioned from the connected state to the inactive state by the network. That is, the UE cannot transition from the idle state to the inactive state, and in order to transition to the inactive state, the UE must be in the connected state. In the inactive state, the network and the UE can quickly transition to the connected state by using the UE context information stored respectively. That is, when the transition from the RRC inactive state to the connected state (or RRC resume) is triggered, the network uses the radio configuration and security information of the UE it has previously to perform a security setting procedure. UE can be transitioned to the connected state without establishing protection procedure in the RRC inactive state, the following operations may be supported.

A DRX cycle is configured for the UE by the network RRC layer, and the UE may perform a DRX operation.

The UE performs CN (Core Network) paging with a predetermined identifier (e.g., 5G-STMSI (Short-Temporary Mobile Subscriber Identity)) and can receive paging information through a paging channel. In addition, the UE may check Radio Access Network (RAN) paging using a predetermined identifier (e.g., Inactive-RNTI (I-RNTI)) and receive paging information through a paging channel.

The UE may measure the signal strength of a neighboring cell and compare the signal strength with a serving cell to perform cell reselection.

In order to check whether the system information possessed by the UE is valid, the system information may be periodically received.

The RRC idle state may be transitioned from the connected state or the inactive state according to RRC release, and from the RRC idle state to the RRC connected state according to RRC establishment. The UE in the idle state monitors the CRC scrambled PDCCH with a Paging-RNTI (P-RNTI), checks the DCI transmitted through the corresponding PDCCH, and confirms the paging channel having the 5GS-TMSI. In addition, the UE in the idle state may measure the signal strength of a neighboring cell for cell reselection.

A UE in a dormant or inactive state may perform Public Land Mobile Network (PLMN) selection, cell (re)selection, location update (e.g., TAU or RNAU), and the like.

AS (Access Stratum) may (re)select a cell to camp based on the PLMN provided by NAS (Non-Access Stratum). At regular intervals, the UE may perform PLMN discovery to camp in a cell with better conditions than the serving cell. for example, when the UE leaves the coverage of a registered PLMN (or serving cell), it can automatically select a new PLNM (i.e., automatic mode) or select a designated PLMN (that is, manual mode).

In addition, for the location update for UE mobility management, UE may performe in units of a tracking area (TA) or a RAN based notification area (RNA). By checking a Tracking Area Identifier (TAI), when the cell moves to a TA different from the TA to which the cell previously camped-on belongs, a TA Update (TAU) may be performed.

In addition, when the UE moves to an RNA different from the previous RNA, RNA Update (RNAU) may be performed. On the other hand, in the RRC connection state, UE mobility may be controlled based on network handover.

Hereinafter, the DRX operation of the terminal will be described.

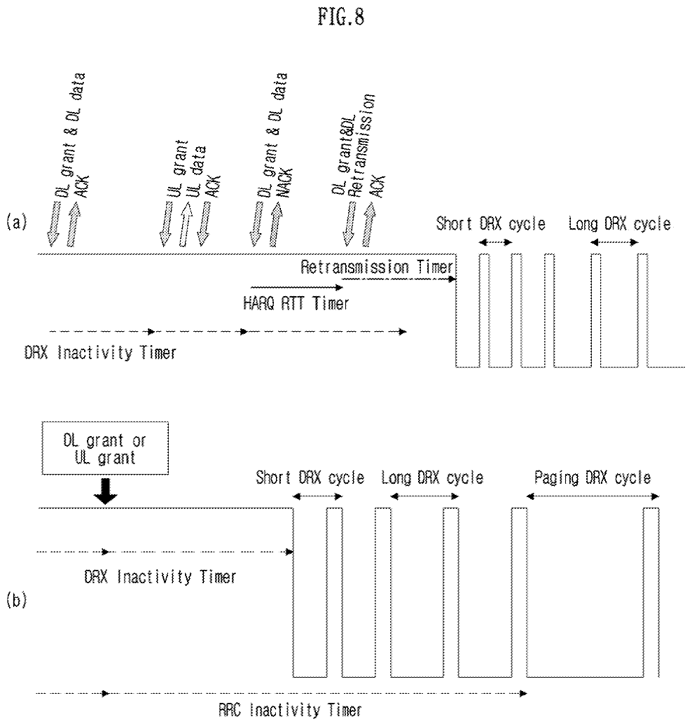

FIG. 8 is a diagram for explaining an exemplary operation of DRX to which the present disclosure can be applied.

FIG. 8 (a) shows an example of a connection-discontinuous reception (Connected-Discontinuous Reception, C-DRX), FIG. 8 (b) is idle-discontinuous reception (Idle-Discontinuous Reception, I-DRX) or inactive—An example of Inactive-Discontinuous Reception (I-DRX) is shown.

C-DRX of FIG. 8(a) means an operation in which the UE periodically performs PDCCH monitoring in order to reduce power consumption in the RRC connection state. That is, the UE does not continuously perform PDCCH monitoring, but performs PDCCH monitoring for a predetermined time period (e.g., On-Duration) within one DRX cycle, and the remaining time Power consumption may be reduced by sleeping during the period, and this DRX cycle may be repeated. DRX operation is performed by the MAC entity, and by RRC signaling for the MAC entity.

Referring to FIG. 8 (a), when the UE in the RRC connection state monitors the PDCCH from the base station and receives a downlink grant (DL grant) through the PDCCH, the PDSCH on the resource allocated by the DL grant It is possible to receive downlink data (DL data) through the Upon receiving the downlink data, the UE may transmit Hybrid Automatic Repeat request (HARQ) ACK/NACK information to the base station through PUCCH or PUSCH. In addition, when the terminal monitors the PDCCH from the base station and receives an uplink grant through the PDCCH, uplink data may be transmitted through the PUSCH on the resource allocated by the UL grant. The base station receiving the uplink data may transmit HARQ ACK/NACK information to the terminal through the PDCCH. If the terminal feeds back the NACK for downlink data, the base station may retransmit the downlink data for which the terminal fails to decode to the corresponding terminal. Similarly, when the base station feeds back NACK for uplink data, the terminal may retransmit downlink data that the base station fails to decode to the base station.

As described above, as the UE monitors the PDCCH, uplink or downlink transmission/reception may be performed. Here, the period after the PDCCH opportunity including the PDCCH indicating that new uplink or downlink transmission exists for the MAC entity of the terminal may be defined as a DRX inactivity timer. After the DRX inactivity timer expires, a C-DRX operation may be performed.

Specifically, when the UE receives a DL/UL grant rather than retransmission, it may (re)start the DRX inactivity timer. If the DL/UL grant for retransmission is received, the DRX inactivity timer may not be updated.

In addition, the UE may start a downlink HARQ Round Trip Time (RTT) timer after transmitting the HARQ feedback for DL data. The downlink HARQ RTT timer may be defined as a minimum interval until a time point at which resource allocation for the next downlink retransmission may occur. If decoding of DL data fails, the UE may start a downlink retransmission timer after the downlink HARQ RTT timer expires. The downlink retransmission timer may be defined as a maximum interval until the downlink retransmission is received.

In addition, the terminal may start an uplink HARQ RTT timer after transmitting UL data. The uplink HARQ RTT timer may be defined as a minimum interval until a time point at which resource allocation for the next uplink retransmission may be made. The UE may start the uplink retransmission timer after the uplink HARQ RTT timer expires. The uplink retransmission timer may be defined as the maximum interval until the uplink retransmission is received.

When the retransmission timer expires and the DRX inactivity timer is not in operation, the UE may perform C-DRX.

Table 2 shows examples of parameters related to DRX operation. DRX parameter information may be included in system information block 2 (SIB2). In addition, the DRX cycle may be set or changed by RRC signaling of the network.

TABLE 2

| DRX parameters | Description |
|---|---|
| drx-HARQ-RTT- | The minimum number of symbols until the next retransmission |
| TimerDL | arrival is expected after the user transmits a NACK, and the |
| | user does not monitor the PDCCH while the RTT Timer is |
| | running. |
| drx-HARQ-RTT- | Minimum number of symbols until the base station transmits |
| TimerUL | a NACK and the next retransmission arrival is expected |
| drx-onDurationTimer | Time to continuously monitor the PDCCH (e.g., 1 to 1200 |
| | ms) |
| drx-InactivityTimer | Time for continuous monitoring of the PDCCH when the user |
| | decodes the PDCCH having scheduling (DL/UL grant) |
| | information (e.g., 0 to 2560 ms) |
| drx- | Number of slots continuously monitored when DL/UL |
| RetransmissionTimerDL/drx- | retransmission is expected (e.g., 10 to 1320) |
| RetransmissionTimerUL | |
| drx-LongCycleStartOffset | Long DRX cycle (e.g. 10 to 10240 ms) |
| drx-ShortCycleTimer | When the Short DRX cycle lasts, DRX is operated according |
| | to the Long DRX cycle. It is a multiple of drx-ShortCycle, |
| | meaning 14 sides 14*drx-ShortCycle. |
| drx-ShortCycle | Time to monitor PDCCH (e.g., 2 to 640 ms) |

In order to receive a message transmitted from the base station even in a terminal state of dormancy or inactive (e.g., system information change, MT (Mobile Terminated), disaster situation notification (ETWS (Earthquake and Tsunami Warning System)) or CMAS ((Commercial Mobile Alert System))) can perform DRX) to process messages. That is, the UE may monitor the CRC scrambled PDCCH with P-RNTI non-contiguously. I-DRX of FIG. 8(b) may be performed by a terminal in a dormant or inactive state. A terminal in a dormant or inactive state may periodically wake up and monitor the PDCCH to check whether a paging message exists. For example, the UE in the RRC connected state may perform C-DRX operation according to a short DRX cycle or a long DRX cycle, and may transition to an inactive state when the RRC inactivity timer expires. The UE in the inactive state wakes up according to the paging DRX cycle and can check whether or not 16 CRC-scrambled PDCCHs with P-RNTI exist. When the PDCCH includes scheduling information of the paging message, the UE may determine whether it is a paging message transmitted to itself by checking the corresponding paging message.

Here, the terminal operation may be different according to the paging message.

The UE may monitor one paging opportunity per DRX cycle (Paging Occasion, PO). The PO corresponds to a set of PDCCH monitoring opportunities through which the paging DCI can be transmitted, and may consist of a plurality of slots. One paging frame (PF) corresponds to one radio frame including one or more POs or serving as a starting point of a PO. That is, a frame in which the UE monitors the PDCCH is referred to as a PF, and the UE may monitor the PDCCH in a specific period (i.e., PO) within the PF, rather than continuously monitoring the PDCCH even within the PF.

The index of PF may be determined as in Equation 4, and PO may be determined as defined in Table 3 according to Ns and is derived from Equation 5.

$${PF}_{index} = ( SFN + {PF}_{offset} ) mod T = \frac{T}{N} \times ( {UE}_{ID} mod N ) , \qquad [ Equation 4 ]$$

$$where N = min ( T , nB ) , T : DRX cycle , nB = 4 T , 2 T , T , \frac{T}{2} , \frac{T}{4} , \frac{T}{8} , \frac{T}{16} , \frac{T}{32} , {UE}_{ID} = 5 G - S - TMSI mode 1024 or IMSI mode 1024$$

$$Ns = max ( 1 , \frac{nB}{T} ) , {i}_{s} = floor ( \frac{{UE}_{ID}}{N} ) mod Ns \qquad [ Equation 5 ]$$

TABLE 3

| Ns | iₛ = 0 | iₛ = 1 | iₛ = 2 | iₛ = 3 |
|---|---|---|---|---|
| 1 | 9 | — | — | — |
| 2 | 4 | 9 | — | — |
| 4 | 0 | 4 | 5 | 9 |

In Equation 4, International Mobile Subscriber Identity (IMSI) may be composed of a PLMN ID and a 10-bit Mobile Subscriber Identification Number (MSIN). Here, the PLMN ID may be composed of a 3-bit MCC (Mobile Country Code) and a 3-bit (or 2-bit) MNC (Mobile Network Code). In Equation 4, T (i.e., DRX cycle) may be defined in system information (e.g., SIB2), and may correspond to a paging DRX cycle in the example of FIG. 8(b). Table 4 below shows P Information included in DCI (e.g., DCI format 1_0) that is CRC scrambled with RNTI is exemplarily shown.

TABLE 4

| Field | Bits | Reference |
|---|---|---|
| Short Message Indicator | 2 | 00: Reserved |
| | | 01: Scheduling information |
| | | only for Paging |
| | | 10: Short message |
| | | 11: Paging and Short |
| | | message |
| Short Message | 8 | 1: SI modification |
| | | 2: ETWS and CMAS |
| | | indication |
| | | 3-8: Not used |
| Frequency domain resource | Variable | — |
| assignment | | |
| Time domain resource | 4 | Row index of the items |
| assignment | | PDSCH allocation in RRC |
| VRB to PRB mapping | 1 | 0: Non-Interleaved |
| | | 1: Interleaved |
| MCS | 5 | — |
| TB Scaling | 2 | — |
| Reserved | 6 | Reserved |

In Table 4, the short message indicator (Short Message Indicator) may indicate whether the corresponding DCI includes a paging or a short message. The short message is used to modify system information and notify a disaster situation. When the Short Message Indicator value is 01, the Short Message field is all reserved because it indicates scheduling information for paging. The remaining fields include scheduling information of the paging message and information necessary for decoding.

Table 5 exemplarily shows information included in a paging message delivered through a paging control channel (PCCH), which is a logical channel.

TABLE 5
-- ASN1START
-- TAG-PAGING-START

| | |
|---|---|
| Paging ::= | SEQUENCE { |
| pagingRecordList | PagingRecordList |
| | OPTIONAL, -- Need N |
| lateNonCriticalExtension | OCTET STRING |
| | OPTIONAL, |
| nonCriticalExtension | SEQUENCE{ } |
| | OPTIONAL |

}

| | |
|---|---|
| PagingRecordList ::= | SEQUENCE (SIZE(1..maxNrofPageRec)) OF Pagi |

ngRecord

| | |
|---|---|
| PagingRecord ::= | SEQUENCE { |
| ue-Identity | PagingUE-Identity, |
| accessType | ENUMERATED {non3GPP} OPTIONAL, |

-- Need N
...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}
-- TAG-PAGING-STOP
-- ASN1STOP

When the inactive terminal receives a paging message, if the PagingUE-Identity field is NG-5G-S-TMSI, it indicates to switch to the idle state, and if I-RNTI, it may indicate to transition to the connected state.

Hereinafter, uplink scheduling without a grant will be described.

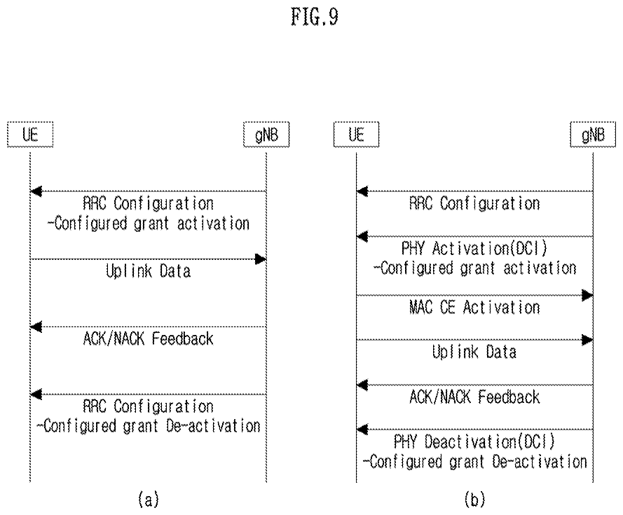

FIG. 9 is a diagram for explaining uplink transmission of a configured grant method to which the present disclosure can be applied.

The base station may dynamically allocate resources for uplink or downlink transmission by transmitting a DCI including an uplink or downlink grant to the terminal through the CRC scrambled PDCCH with C-RNTI. For example, while the UE in the active state performs C-DRX, it is possible to check whether there is dynamic resource allocation by monitoring the PDCCH every DRX cycle.

Unlike the dynamic allocation method, the base station may statically allocate a periodic uplink transmission resource through an RRC message to the terminal. In this case, since uplink grant information is not provided using DCI through the PDCCH, it may be referred to as a grant-free or configured grant scheme.

The configured grant scheme may include types 1 and 2.

Referring to FIG. 9 (a), the configured grant type 1 is information indicating activation of the corresponding resource allocation information along with the resource allocation information that the base station can use to the terminal through the RRC message. It may be a way to provide If the base station instructs deactivation of the resource allocation information, the RRC message may be provided to the terminal. Accordingly, the UE may use uplink resources without an uplink grant through a separate PDCCH DCI.

In the configured grant type 2, the base station provides resource allocation information that the terminal can use in advance through an RRC message, and the base station transmits information indicating activation or deactivation of the resource allocation information to the terminal through the PDCCH DCI. For example, when DCI transmitted through CRC-scrambled PDCCH with CS (Configured Scheduling)-RNTI includes an activation command for a configured grant, the UE can use a predetermined resource and includes a deactivation command. The UE may stop using the resource.

Table 6 exemplarily shows an information element for setting a configured grant, which is included in the RRC message.

TABLE 6
ConfiguredGrantConfig information element

-- ASN1START
-- TAG-CONFIGUREDGRANTCONFIG-START

| | |
|---|---|
| ConfiguredGrantConfig ::= | SEQUENCE { |
| frequencyHopping | ENUMERATED {intraSlot, interSlot} |

OPTIONAL, -- Need S

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, |

sym4x14, sym5x14, sym8x14, sym10x14, sym16x14, sym20x14,

sym32x14, sym40x14, sym64x14,

sym80x14, sym128x14, sym160x14, sym256x14, sym320x14, sym512x14,

sym640x14, sym1024x14, sym1280x14,

sym2560x14, sym5120x14,

sym6, sym1x12, sym2x12, sym4x12,

sym5x12, sym8x12, sym10x12, sym16x12, sym20x12, sym32x12,

sym40x12, sym64x12, sym80x12,

sym128x12, sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

```
PathlossReferenceRSs-1),
    ...,
    [[
```

| | |
|---|---|
| pusch-RepTypeIndicator-r16 | ENUMERATED {pusch-RepTypeA,pusch- |
| RepTypeB} | OPTIONAL, -- Need M |

frequencyHoppingPUSCH-RepTypeB-r16 ENUMERATED {interRepetition,

| | |
|---|---|
| interSlot} | OPTIONAL, -- Cond RepTypeB |
| timeReferenceSFN-r16 | ENUMERATED {sfn512} |

```
OPTIONAL -- Need S
    ]]
  }
OPTIONAL, -- Need R
  ...,
  [[
```

| | |
|---|---|
| cg-RetransmissionTimer-r16 | INTEGER (1..64) |

OPTIONAL, -- Need R

| | |
|---|---|
| cg-minDFI-Delay-r16 | ENUMERATED |
| | {sym7, sym1x14, sym2x14, sym3x14, |

sym4x14, sym5x14, sym6x14, sym7x14, sym8x14,

sym9x14, sym10x14, sym11x14,

sym12x14, sym13x14, sym14x14, sym15x14, sym16x14

}

OPTIONAL, -- Need R

| | |
|---|---|
| cg-nrofPUSCH-InSlot-r16 | INTEGER (1..7) |

OPTIONAL, -- Need R

| | |
|---|---|
| cg-nrofSlots-r16 | INTEGER (1..40) |

OPTIONAL, -- Need R

| | |
|---|---|
| cg-StartingOffsets-r16 | CG-StartingOffsets-r16 |

OPTIONAL, -- Need R

| | |
|---|---|
| cg-UCI-Multiplexing | ENUMERATED {enabled} |

OPTIONAL, -- Need R

| | |
|---|---|
| cg-COT-SharingOffset-r16 | INTEGER (1..39) |

OPTIONAL, -- Need R

| | |
|---|---|
| betaOffsetCG-UCI-r16 | INTEGER (0..31) |

OPTIONAL, -- Need R

| | |
|---|---|
| cg-COT-SharingList-r16 | SEQUENCE (SIZE (1..1709)) OF CG- |
| COT-Sharing-r16 | OPTIONAL, -- Need R |
| harq-ProcID-Offset-r16 | INTEGER (0..15) |

OPTIONAL, -- Need M

| | |
|---|---|
| harq-ProcID-Offset2-r16 | INTEGER (0..15) |

OPTIONAL, -- Need M

| | |
|---|---|
| configuredGrantConfigIndex-r16 | ConfiguredGrantConfigIndex-r16 |

OPTIONAL, -- Cond CG-List

| | |
|---|---|
| configuredGrantConfigIndexMAC-r16 | ConfiguredGrantConfigIndexMAC-r16 |

OPTIONAL, -- Cond CG-List

| | |
|---|---|
| periodicityExt-r16 | INTEGER (1..5120) |

OPTIONAL, -- Need R

| | |
|---|---|
| startingFromRV0-r16 | ENUMERATED {on, off} |

OPTIONAL, -- Need R

| | |
|---|---|
| phy-PriorityIndex-r16 | ENUMERATED {p0, p1} |

OPTIONAL, -- Need R

| | |
|---|---|
| autonomousTx-r16 | ENUMERATED {enabled} |

OPTIONAL -- Cond LCH-BasedPrioritization
]]
}
CG-UCI-OnPUSCH ::= CHOICE {

| | |
|---|---|
| dynamic | SEQUENCE (SIZE (1..4)) OF BetaOffsets, |
| semiStatic | BetaOffsets |

}

As shown in Table 6, the configured grant configuration information may include a time-frequency location, period, offset, etc. of a resource usable by the terminal.

Hereinafter, the operation of the UE in the RRC inactive state will be described in more detail.

RRC inactive state includes a CM-connected (Connection Management-Connected) state. That is, the RRC inactive state may correspond to a state in which the radio bearer with the network is suspended in the RAN, but the connection with the core network (CN) is established. Therefore, the base station (last serving gNB) that last served the terminal maintains the NG connection information and terminal context information for the terminal in the Access and Mobility Management Function (AMF) and User Plane Function (UPF). The information may be used again when the corresponding terminal accesses the network again. In addition, the terminal in the RRC inactive state is within the RNA range. It can move freely without informing the RAN. For example, even if the terminal leaves the service coverage of the serving base station, if the base station to be camped belongs to the same RNA as the serving base station, RNAU may not be performed.

When the base station receives data to be transmitted to the inactive terminal from the UPF, or receives signaling related to the inactive terminal from the AMF, the base station may perform paging for the corresponding terminal. When the base station is connected to the neighboring base station through an Xn interface and the neighboring base station belongs to the same RNA as the base station, paging may be started by the RAN (i.e., the base station that last served). For example, when the base station that last served the terminal receives a UE context release command from the AMF, the corresponding base station performs paging to the corresponding terminal to neighboring base stations belonging to the same RNA as itself and connected through the Xn interface. You can instruct them to send Here, the terminal identifier is set to 5G-S-TMSI, so that the terminal in the inactive state may transition to the idle state.

In addition, the base station may determine whether to transition the terminal to the inactive state based on information provided from the AMF (e.g., network assistance information (Network Assistance Information)). Here, the information provided from the AMF is a registration area (or RNA), a periodic registration update timer (Periodic Registration Update timer) (or a periodic RNA update timer Periodic RNA update timer), terminal context information, terminal DRX information, It may include one or more of expected UE behavior information.

For example, when the periodic RNA update timer expires, a periodic registration update procedure may be performed, and through this, the terminal may inform the network that the terminal is still in operation. In the base station, a periodic RNA update guard timer may operate, and the corresponding timer may be set to a value greater than the size of the periodic RNA update timer received from the AMF. When the corresponding timer expires in the base station, the base station may release the connection with the AMF through an AN link release process.

The inactive terminal may receive RNAinformation from the last serving base station. Here, the RNA may include one or more cells within the CN registration region.

Cells belonging to the same single RNA may all be connected by an Xn interface. The UE may periodically perform RNAU, or may perform RNAU even when the cell selected in the cell reselection process does not belong to the previous RNA.

Table 7 shows an example of a timer operating in the RRC inactive state.

TABLE 7

| Timer | Start | Stop | At expiry |
|---|---|---|---|
| T380 | When receiving t380 | When RRC | Start RNA update |
| | (PeriodicRNAU- | resume/setup/release | procedure |
| | TimerValue) from | is received | |
| | RRC release | | |

Referring to Table 7, the timer named T380 may be started when the terminal receives the T380 timer value (i.e., t380 (PeriodicRNAU-TimerValue)) through the RRC release message. When receiving an RRC resume, RRC setup, or RRC release message, the T380 timer may stop. When the T380 timer expires, the UE may perform an RNA update procedure.

As a specific example, when the inactive terminal receives the T380 timer value (i.e., t380 (PeriodicRNAU-TimerValue)) from the base station last served, the T380 timer may be started. If the cell reselection condition is triggered, the UE transmits an RRC resume request message to the target cell and receives RRC resume, RRC setup, and RRC release messages in response thereto, the UE may stop the T380 timer. If a suspend configuration periodic RNA update timer is present in the RRC release message, the T380 may operate again.

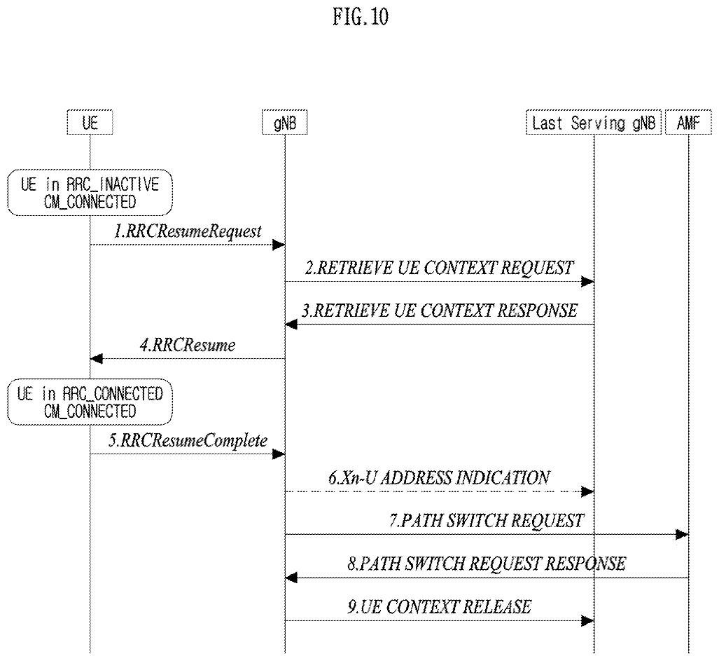

FIG. 10 is a diagram illustrating an example of an RRC state transition triggered by a terminal to which the present disclosure may be applied.

In the example of FIG. 10, the terminal is in the RRC deactivation and CM-connected state in the last serving base station (e.g., the first base station), the RRC connection state in the new base station (e.g., the second base station) can be transferred to The transition from the RRC inactive state to the RRC connected state may be triggered by the UE.

In step 1, the terminal may transmit an RRC resume request (Resume Request) message including the I-RNTI provided from the first base station to the second base station.

In step 2, the second base station specifies the first base station from the base station identification information included in the I-RNTI, and transmits a Retrieve UE Context Request message to the corresponding base station, and in step 3, the first A Retrieve UE Context Response message may be received from the base station.

When the second base station successfully receives the terminal context information, in step 4, the second base station may transmit an RRC resume message to the terminal.

The terminal receiving the RRC resume message in step 4 may transition to the RRC connected state, may transmit an RRC resume complete (Resume Complete) message to the second base station in step 5.

In step 6, the second base station may inform the first base station of the Xn-U address in order to prevent data loss when data to be transmitted to the terminal remains in the buffer of the first base station.

In step 7, the second base station transmits a path switching request (Path Switching Request) message to the AMF, and in step 8 may receive a path switching response (Path Switching Response) message from the AMF.

In step 9, the second base station may transmit a UE context release message to the first base station.

Thereafter, the second base station may perform a DRX cycle of the terminal, RNA reconfiguration, etc., and may transition the terminal to an idle state.

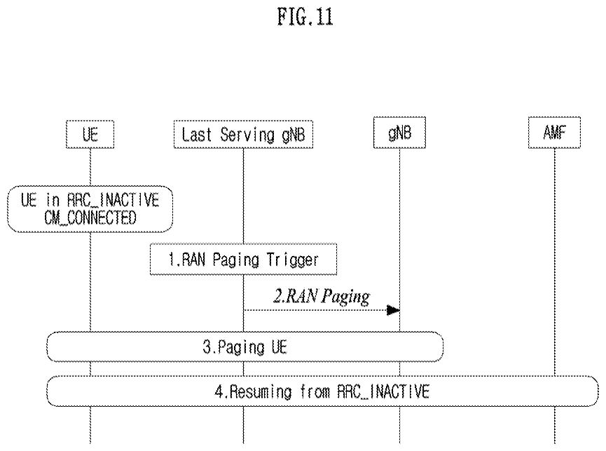

FIG. 11 is a diagram illustrating an example of an RRC state transition triggered by a network to which the present disclosure may be applied.

In the example of FIG. 11, the terminal in the RRC deactivation and CM-connected state in the last serving base station (e.g., the first base station), the RRC connection state in the new base station (e.g., the second base station) can be transferred to This transition from the RRC inactive state to the RRC connected state may be triggered by the network.

When the first base station triggers RAN paging in step 1, the first base station may transmit a RAN paging message to the second base station. For example, when the first base station receives downlink data to be transmitted to the terminal from the UPF or receives signaling related to the terminal from the AMF, RAN paging may be performed.

Here, the RAN paging message may be transmitted to a neighboring base station (e.g., a second base station) belonging to the same RNA as the first base station and connected to the first base station through an Xn interface.

Upon receiving the RAN paging message in step 3, the second base station may transmit the paging message to the terminal using the I-RNTI. When the terminal successfully receives the paging message, in order to get out of the RRC inactive state, in step 4, an RRC resume request message may be transmitted to the second base station.

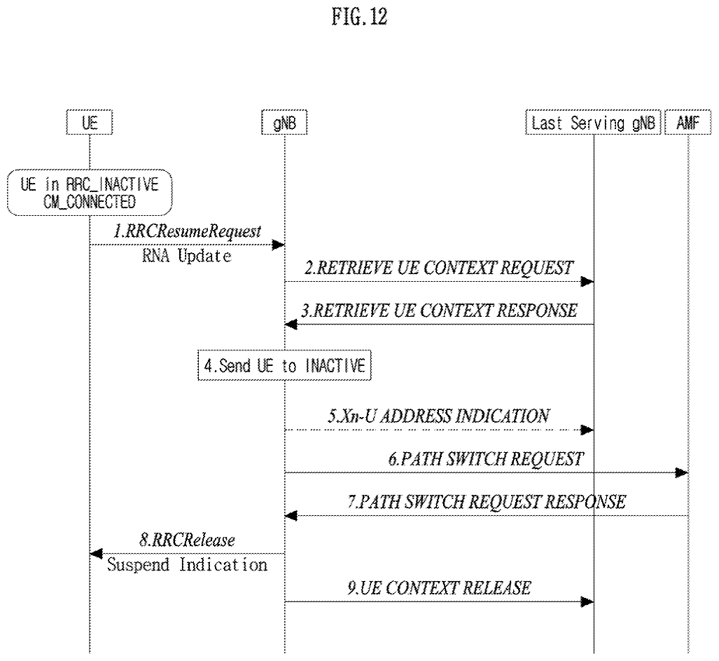

FIG. 12 is a diagram showing an example of an RNA update process to which the present disclosure can be applied.

In the example of FIG. 12, the terminal leaves the RNA to which the first base station belongs in the RRC deactivation and CM-connected state in the last serving base station (e.g., the first base station) and the base station belonging to the new RNA (For example, the second base station) may perform an RNA update procedure. In this RNA update process, terminal context information may be relocated.

In step 1, the UE may transmit an RRC resume request message including the I-RNTI provided from the first base station and the RNA update as a resume cause to the second base station.

In step 2, the second base station specifies the first base station from the base station identification information included in the I-RNTI, transmits a terminal context extraction request message to the corresponding base station, and extracts the terminal context from the first base station in step 3 You can receive a response message.

The second base station successfully receives the terminal context information, and in step 4, the second base station may determine to maintain the terminal in an RRC inactive state.

In step 5, the second base station may inform the first base station of the Xn-U address in order to prevent data loss when data to be transmitted to the terminal remains in the buffer of the first base station.

In step 6, the second base station may transmit a path switching request message to the AMF, and may receive a path switching response message from the AMF in step 7.

In step 8, the second base station may transmit to the terminal including information indicating radio bearer suspend in the RRC release message in order to instruct the terminal to maintain the RRC inactive state.

In step 9, the second base station may transmit a UE context release message to the first base station.

On the other hand, in the example of FIG. 12, the first base station receiving the terminal context extraction request message from the second base station may determine to transition the terminal in the RRC inactive state attempting the RNA update to the RRC idle state. In this case, the first base station may transmit a terminal context extraction failure message to the second base station. Accordingly, the second base station transmits an RRC release message to the terminal, and the terminal can transition to dormant state.

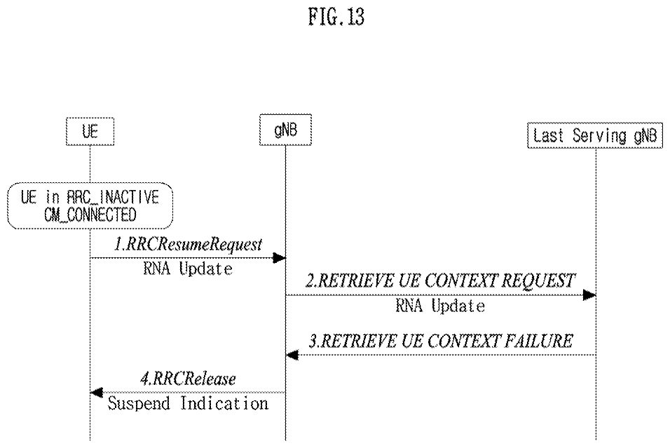

FIG. 13 is a diagram illustrating an example of a periodic RNA update process to which the present disclosure can be applied.

In the example of FIG. 13, the terminal is another base station belonging to the same RNA as the first base station in the RRC deactivation and CM-connection state in the last serving base station (e.g., the first base station) (e.g., the second base station) may perform a periodic RNA update procedure. In this RNA update process, terminal context information may not be rearranged.

In step 1, when the periodic RNA update timer provided from the first base station expires, the UE may transmit an RRC resume request including RNA update as a resumption reason to the second base station currently camping. In addition, the UE may include the I-RNTI provided from the first base station in the RRC resume request.

In step 2, the second base station specifies the first base station from the base station identification information included in the I-RNTI, and may transmit a terminal context extraction request message including an RNA update as a request reason to the corresponding base station.

The first base station receiving the terminal context extraction request message including the RNA update in step 3 may determine to maintain the terminal context information without sending it to the second base station. For example, when the second base station belongs to the same RNA as the first base station, the first base station may determine not to rearrange the terminal context information. Accordingly, the first base station may transmit a Retrieve UE Context Failure message to the second base station.

In addition, the first base station may store the information (e.g., C-RNTI, PCI (Physical Cell Identifier), etc.) of the second base station to be used when there is a next restart attempt of the terminal.

In step 4, in order to instruct the terminal to maintain the RRC inactive state, the second base station may transmit to the terminal including information indicating radio bearer stop in the RRC release message.

Hereinafter, embodiments of the present disclosure for a terminal in an inactive state to perform uplink transmission will be described.

In the NR system, the RRC inactive state may correspond to a state in which the RRC connection is suspended, specifically, a state in which the radio bearer (RB) is stopped. Here, the RB may include a data RB for data signal transmission and a signaling RB for control signal transmission. When the UE in the RRC connected state receives an RRC release message including information indicating RB stop from the network, the UE in the RRC connected state may transition to the RRC inactive state. This RRC release message may include information such as a terminal identifier (e.g., I-RNTI) in an inactive state, a paging period, and an RNAU period.

When a terminal originating (MO) message occurs in a terminal in an inactive state, the terminal may align uplink synchronization through random access and transmit an RRC resume request message to the network. When a mobile terminated (MT) message occurs in the network, the base station may transmit a paging message to the corresponding terminal to instruct the terminal to transmit an RRC resume request message. In addition, the case in which the RRC resume request is performed is not limited to the above examples, and, for example, the RRC resume request may be performed for RNAU.

When the network receives the RRC resume request from the terminal, the message responding to the terminal, the subsequent procedure, etc. may be determined differently depending on the resumption reason, the presence or absence of the terminal context, RNA information, and the like. For example, if the terminal context information cannot be confirmed in the network, the bearer and security can be established through the RRC establishment process. Alternatively, if the resumption reason is terminal originating or terminal destination and the network has terminal information, an RRC reconnection message may be transmitted to the terminal. Alternatively, if the RRC resume reason is RNAU, an RRC release message may be transmitted to the UE.

Conventionally, uplink transmission of the terminal in an inactive state was not supported, and the terminal in which all RBs are stopped is RRC first through the RRC resume procedure for MT (or downlink) or MO (or uplink) data transmission and reception. It was necessary to transition to the connected state. Recently, with respect to the terminal in the inactive state, there is a discussion in progress to allow the transmission of small data (small data) that occurs infrequently. Small data may include, for example, instant messages, keep-alive traffic, periodic location information, sensor information, smart meter information, and the like. However, even when the terminal in the inactive state attempts to transmit small data, it must transition to the RRC connected state every time, and thus signaling overhead and power consumption may be problematic. Accordingly, a method for reducing unnecessary signaling overhead and power consumption by reducing an RRC state change (or transition to an RRC connected state) procedure for small data transmission is being discussed. Also, a method of using the configured grant type 1 in order for the terminal in an inactive state to efficiently transmit small data is being discussed. For example, the UE may receive configuration information for grant type 1 configured from the base station in the RRC connection state in advance through RRC signaling, and then perform uplink transmission in the configured grant scheme in the inactive state. However, in the present disclosure, the resource setting for the UE in an inactive state to perform uplink transmission is not limited to the configured grant type 1 scheme, and the scope of the present disclosure is based on 25 preset resources, the UE performs uplink transmission may include various methods such as any grant-free or periodic uplink resource configuration. Also, even when the configured grant type 1 method is applied, the scope of the present disclosure is not limited to the resource setting procedure of the configured grant type 1 method described in the embodiments, and the resource of the configured grant type 1 method configured in an arbitrary method is It may include being preset.

In order for a terminal to perform uplink transmission to a base station in a wireless communication system, uplink synchronization must be maintained or timing advance (TA) must be valid. Since the conventional terminal in an inactive state does not support uplink transmission, there is no need to consider uplink synchronization (or TA). However, for various purposes such as small data transmission using the configured grant type 1 (that is, the present disclosure is not limited to the configured grant type 1 and/or small data transmission), the terminal in an inactive state performs uplink transmission. For this purpose, it is required for the terminal in an inactive state to maintain uplink synchronization. Here, it is difficult to apply the TAC to the MAC RAR or MAC CE method for the UE in the RRC connection state to maintain uplink synchronization with the serving cell, to the UE in the inactive state. Therefore, a new procedure for maintaining uplink synchronization with the network for a terminal in an inactive state is required.

As such, in order for the terminal in the inactive state to perform uplink transmission, it is required for the terminal in the inactive state to maintain uplink time synchronization. In order for the terminal in the inactive state to maintain uplink time synchronization, while the uplink time alignment is maintained, the terminal in the inactive state may perform uplink transmission or receive a timing advance command from a network (or base station). An operation for maintaining uplink time synchronization by the terminal in an inactive state may be initiated by the terminal or may be initiated by the network (or base station). In addition, embodiments of the present disclosure may include methods in which the terminal in an inactive state maintains uplink time synchronization with respect to a serving cell or a target cell.

Hereinafter, embodiments of the present disclosure for maintaining uplink synchronization for a terminal in an inactive state will be described. Specifically, the present disclosure includes an embodiment in which a terminal in an inactive state maintains uplink synchronization with a serving cell, and an embodiment in which a terminal in an inactive state maintains uplink synchronization with a cell other than the serving cell.

### Embodiment 1

This embodiment relates to a method for maintaining uplink synchronization for a serving cell by a terminal in an inactive state.

In this embodiment 1, the base station may correspond to a base station serving as the terminal's serving cell.

When the terminal in the inactive state receives the TAC from the base station, the TAT may be operated and the uplink transmission time may be determined by reflecting the TAC value. If the TAT expires, the UE may determine that the uplink synchronization (or TA) is invalid or out of synchronization (out of synchronization state). In this case, the UE may release resource configuration for the serving cell. The release of resource setting flushes the HARQ buffer for holding data to be transmitted or retransmitted in uplink; notify the RRC layer to release PUCCH and/or sounding reference signal (SRS) transmission resources; and/or clearing all configured downlink grants or uplink grants.

According to this embodiment, the terminal in the inactive state may perform uplink transmission to the base station when a predetermined trigger condition is satisfied.

The predetermined trigger condition may include a condition for whether uplink synchronization (or TA) maintenance is required. For example, a predetermined trigger condition may be defined after TAT start, before TAT expiration, or in relation to T380 timer expiration.

Uplink transmission of the terminal in an inactive state may be performed on a preset uplink resource. The preset uplink resource may include the configured grant type 1 configuration resource. In this case, the terminal may have received configuration information on the preset uplink resource from the base station in the RRC connection state before the inactive state.

In addition, the uplink transmission of the terminal in an inactive state may include one or more of small data or dummy data. For example, the terminal may transmit small data to be transmitted when it exists, may transmit dummy data when small data does not exist, or when the size of small data is smaller than a preset uplink resource, small Data and dummy data may be transmitted simultaneously. In addition, the dummy data may correspond to any data or padding bits that do not include user data, or the dummy data may be configured in the form of a signaling bit of a predetermined pattern indicating that uplink synchronization is required to be maintained.

That is, for a terminal in an inactive state, a periodic uplink transmission resource may be preset by the base station of the serving cell. In an uplink transmission opportunity according to a preset uplink transmission resource, the terminal may transmit small data, transmit dummy data, or skip without transmitting anything.

When the base station receives uplink transmission (e.g., small data and/or dummy data) from the terminal in an inactive state, it may transmit a TAC to the terminal. The TAC value may be determined based on the time point at which the uplink transmission from the terminal is received by the base station. The base station may transmit the TAC based on the paging period of the terminal or when a predetermined condition is satisfied. For example, the predetermined condition may be related to the TAT expiration time of the terminal expected by the base station. In addition, the TAC may be transmitted through an RRC message from the base station to the terminal. For example, the RRC message may include an RRC reconfiguration, an RRC release, a paging message, and the like.

In addition, when the base station receives the uplink transmission from the terminal in an inactive state, it is possible to prevent the AN link release by restarting the periodic RNA update guard timer received from the AMF.

When the terminal receives the TAC, it may (re)start the TAT.

In this way, the base station may provide the TAC to the terminal based on the uplink transmission of the terminal in an inactive state, and thus the TAT of the terminal may be maintained without expiration.

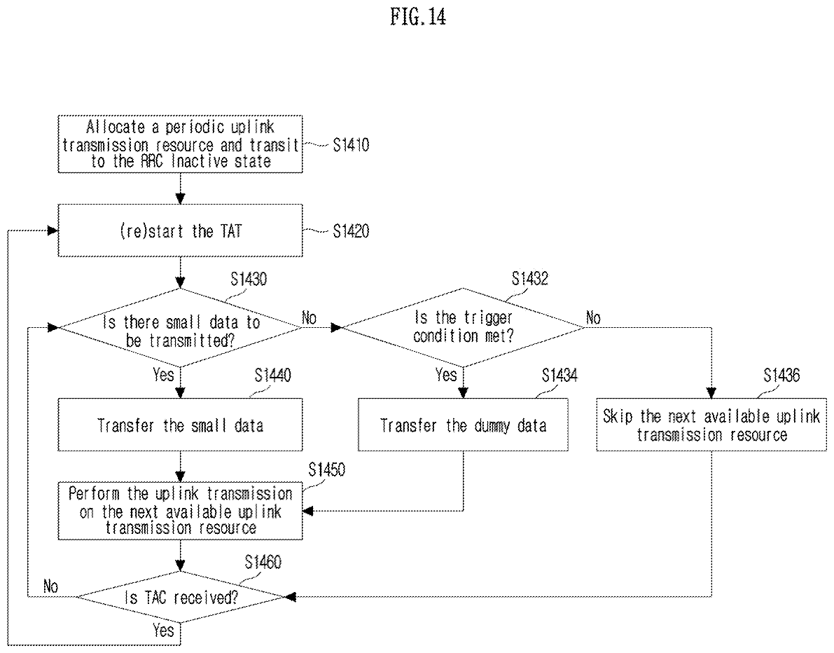

FIG. 14 is a diagram for explaining an uplink synchronization maintenance operation of an inactive terminal to which the present disclosure can be applied.

In step S1410, a periodic uplink transmission resource may be allocated and activated from the base station to the terminal. For example, grant type 1 configuration information configured for the terminal may be provided and applied. Also, in step 1420, the UE may (re)start TAT. For example, the terminal may receive and apply the TAC through an RRC message or a paging message provided from the base station, and (re)start the TAT. In addition, according to the configuration from the base station, the terminal may transition from the RRC connected state to the inactive state.

In step S1430, the terminal may determine whether there is small data to be transmitted. If there is small data to be transmitted, the MAC entity of the terminal may transmit the small data to the physical layer in step S1440.

If there is no small data, the terminal may determine whether the trigger condition is satisfied in step S1432. For example, the trigger condition may include one or more of receiving a TA update command from a base station after a predetermined time elapsed since the TAT was initiated, a predetermined time remaining until the TAT expires, or after a periodic RNA update timer expires.

When the trigger condition is satisfied, the MAC entity of the terminal may transmit dummy data to the physical layer in step S1434. Alternatively, the MAC entity may instruct the physical layer to transmit dummy data and generate dummy data in the physical layer.

In step S1450, the terminal may perform uplink transmission (e.g., small data or dummy data transmission) on the next available uplink transmission resource (e.g., a resource allocated according to the configured grant type 1). have. Alternatively, although not shown in FIG. 14, when a trigger condition is satisfied while small data exists, small data or small data and dummy data may be transmitted together.

In step S1460, the terminal may determine whether the TAC is received from the base station. The TAC may be received through a paging message. When the TAC is received, the UE may apply it and (re)start the TAT in step S1420. If the TAC is not received, in step S1430, the UE may determine whether small data to be transmitted through the uplink exists while the previously started TAT is in operation.

If the trigger condition is not satisfied in step S1432, the terminal may skip the next available uplink transmission resource in step S1436. After skipping the uplink transmission resource, when the TAC is not received, the UE may determine whether there is data to be transmitted in the next available uplink transmission resource.

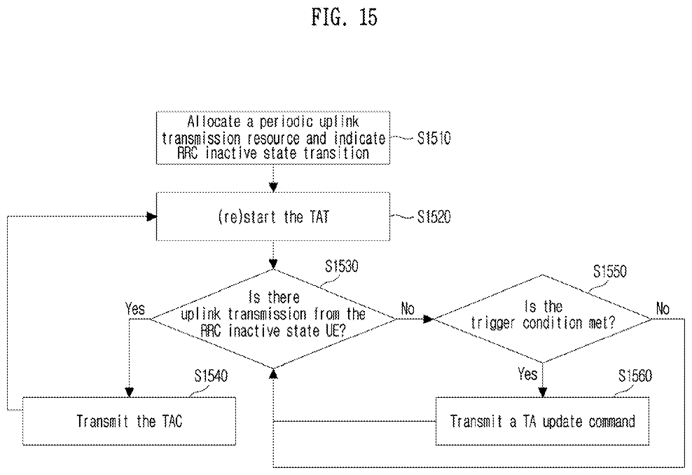

FIG. 15 is a diagram for explaining an uplink synchronization maintenance operation of a base station for an inactive terminal to which the present disclosure can be applied.

In step S1510, the base station may allocate a periodic uplink transmission resource to the terminal. For example, the base station may provide grant type 1 configuration information configured to the terminal in the RRC connection state through the RRC message. In addition, the base station may instruct the terminal to transition from the RRC connected state to the inactive state.

In step S1520, the base station may (re)start the TAT for the terminal. For example, the base station may transmit the TAC to the terminal and (re)start the TAT accordingly.

In step S1530, the base station may determine whether uplink transmission is received from the terminal in an inactive state. The uplink transmission may be received on an uplink transmission resource according to the configured grant type 1 preset by the base station to the terminal. In addition, the uplink transmission from the terminal may include one or more of small data and dummy data.

When the uplink transmission is received from the terminal, the base station may transmit the TAC to the corresponding terminal in step S1540. The TAC may be transmitted to the UE through a paging message. As the TAC is transmitted, the base station may (re)start the TAT in step S1520.

If the uplink transmission is not received from the terminal, the base station may determine whether the trigger condition is satisfied in step S1550. For example, the trigger condition may be defined based on a predetermined time remaining until the TAT expires.

If the trigger condition is satisfied, the base station may transmit a TA update command to the terminal in step S1560. In addition, the base station may monitor whether the uplink transmission is received from the terminal in step S1530.

If the trigger condition is not satisfied, the base station may monitor whether the uplink transmission is received from the terminal in step S1530.

Hereinafter, specific embodiments of the present disclosure related to the examples of FIGS. 14 and 15 will be described.

### Embodiment 1-1

This embodiment relates to an uplink synchronization maintenance operation of a terminal in an inactive state initiated by the terminal.

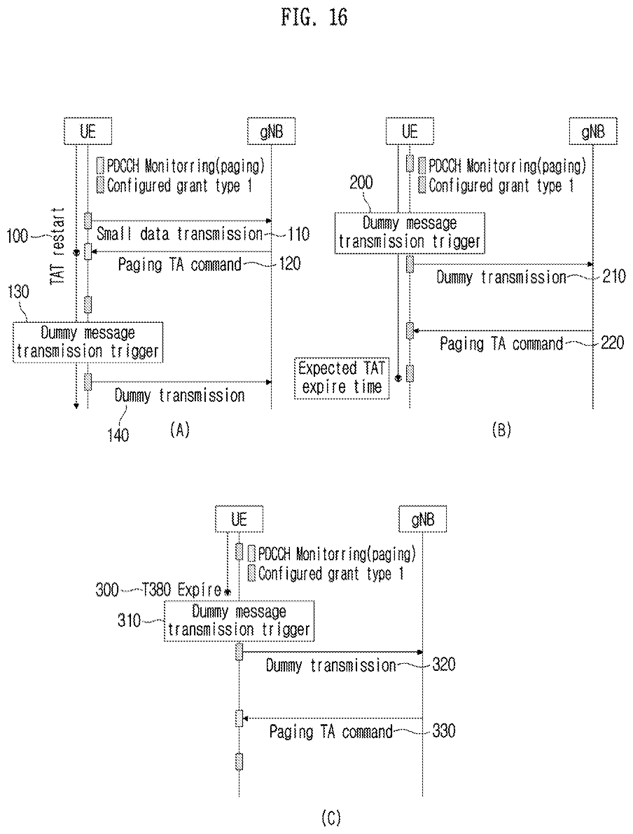

FIG. 16 is a diagram for explaining examples of an uplink synchronization maintenance operation initiated by a terminal in an inactive state to which the present disclosure can be applied.

Examples of FIG. 16 correspond to examples of trigger conditions of a terminal in which an inactive terminal performs uplink transmission (e.g., small data and/or dummy data transmission) to maintain uplink synchronization with a base station do. A case in which the expected TAT expire time is not shown in the examples of FIG. 16 corresponds to a case where the TAT length is sufficiently long. In addition, the case where the TAT (re-)start time is not shown in the examples of FIG. 16 corresponds to a case where the TAT was started sufficiently earlier.

FIG. 16 (a) shows the operation of the terminal and the base station based on the time (100) at which the TAT (re)start.

For example, the terminal transmits small data to the base station (110), and receives a paging message including the TAC from the base station (120), and thus the TAT may be (re)started (100). When a predetermined trigger condition is satisfied based on the (re)start time of the TAT (130), the terminal performs uplink transmission (e.g., small data and/or dummy data transmission) for maintaining uplink synchronization. can (140).

Here, the predetermined trigger condition may be defined as a time point spaced apart by a predetermined time after TAT (re)start (i.e., a predetermined time has elapsed after TAT (re)start). Here, the predetermined time may be defined as the preset number of uplink transmission opportunities, the number of paging opportunities, a predetermined time interval, or a predetermined timer.

After the terminal performs uplink transmission for maintaining uplink synchronization, it may receive a TAC from the base station at the next available paging opportunity. Upon receiving the TAC, the UE may restart the TAT. For example, after step 140 of FIG. 16A, steps 120 (and steps 100) to 140 may be repeated.

FIG. 16 (b) shows the operation of the terminal and the base station based on the time point 230 when the TAT expires.

For example, when a predetermined trigger condition is satisfied based on the time point 230 at which the TAT expires (200), the terminal transmits an uplink for maintaining uplink synchronization (e.g., small data and/or dummy data transmission) may be performed (210). Accordingly, the terminal may receive the TAC from the base station at the next available paging opportunity (220). Upon receiving the TAC, the UE may restart the TAT.

Here, the predetermined trigger condition may be defined as a time point that is spaced apart by a predetermined time before the TAT expires (i.e., a predetermined time remains until the TAT expiration time). Here, the predetermined time may be defined as the preset number of uplink transmission opportunities, the number of paging opportunities, a predetermined time interval, or a predetermined timer.

In addition, since the TAT has not yet expired at the time of determining whether the predetermined trigger condition is satisfied, an expected TAT expiration time may be applied. The expected TAT expiration time may be calculated as a time point in which the time length of the TAT is added from the time when the terminal receives the TAC from the base station (or the time when the TAT is (re)started based on the received TAC).

FIG. 16 (c) shows the operation of the terminal and the base station based on the time when the periodic RNA update timer (i.e., T380) expires.

In the example of FIG. 16(c), it is assumed that the TAT of the terminal is in operation before the T380 timer expires, and the expected TAT expiration time is sufficiently left.

For example, the terminal when a predetermined trigger condition is satisfied (or small data and/or dummy data transmission condition is triggered) based on the time point 300 when the T380 timer expires (310), the terminal may perform uplink transmission (e.g., small data and/or dummy data transmission) for maintaining uplink synchronization (320). Accordingly, the terminal may receive the TAC from the base station at the next available paging opportunity (330). Upon receiving the TAC, the UE may (re)start the TAT.

The UE may start the T380 timer when the periodic RNA update timer value (t380) exists in the stop setting of the RRC release message, and may perform RNA update when the T380 timer expires. Here, the expiration of the T380 timer may be used as a predetermined trigger condition of uplink transmission for maintaining uplink synchronization.

In this embodiment, when the terminal T380 expires, instead of transmitting an RRC resume message to the base station to perform the RNA update process, uplink transmission for maintaining uplink synchronization (e.g., small data and/or dummy data transmission). That is, the uplink transmission triggered when T380 expires triggers TAC transmission for maintaining uplink synchronization and serves as an RRC resume message to inform the base station of keep-alive of the terminal. have. When the base station receives an uplink transmission (e.g., small data and/or dummy data transmission) for maintaining uplink synchronization from a terminal in an inactive state during a periodic RNAupdate timer and a guard timer operation, the activity of the terminal through initialization—Can be maintained.

The example of FIG. 16(c) may be applied in an environment in which uplink synchronization of a terminal in an inactive state must be maintained (i.e., an environment in which small data transmission must be continuously allowed).

In the examples of FIGS. 16 (a) to 16 (c), receiving an uplink transmission (e.g., small data and/or dummy data transmission) for maintaining uplink synchronization from a terminal in an inactive state Based on this, the base station may transmit the TAC through the paging message according to the paging period of the terminal. After uplink transmission for maintaining uplink synchronization, the UE monitors the CRC scrambled PDCCH with P-RNTI at the next available paging opportunity to obtain DCI, and confirms and applies the TAC in the paging message.

Here, the TAC in the paging message may be set as shown in Table 8. Table 8 may correspond to a part of the paging message format shown in Table 5.

TABLE 8

| | |
|---|---|
| TA command | 6 bits(0~64): −32~32, N_{TA}_{_{—}}new = N_{TA}_{_{—}}old + (T_{A} −31) · 16 · 64/2^{μ} |
| pagingUE- | I-RNTI |
| Identity | |

As shown in Table 8, the TAC may be composed of a 6-bit TAC field, and Equation 3 may be applied. Also, the pagingUE-Identity field in the paging message may be set to I-RNTI. In this case, the terminal in the inactive state enters the inactive state without transitioning to the connected state.

In the examples of FIGS. 16 (a) to 16 (c), even when the predetermined trigger condition is not satisfied, the terminal in an inactive state performs uplink transmission (e.g., small data transmission) to the base station can also be done When the predetermined trigger condition is satisfied, the inactive terminal transmits small data (or dummy data together with the small data) when there is small data to be transmitted to the base station, and transmits the dummy data when there is no small data to transmit By transmitting to the base station, it is possible to inform the base station that uplink synchronization maintenance is required.

In addition, the base station may provide a TAC based on uplink transmission transmitted when the predetermined trigger condition is satisfied from the terminal in the inactive state, regardless of the predetermined trigger condition of the terminal in the inactive state TAC may be provided based on any uplink transmission. That is, the base station may provide TAC to the terminal when there is uplink transmission without distinguishing the type of uplink transmission transmitted from the terminal in an inactive state.

### Embodiment 1-2

This embodiment relates to an uplink synchronization maintenance operation of a terminal in an inactive state initiated by a base station.

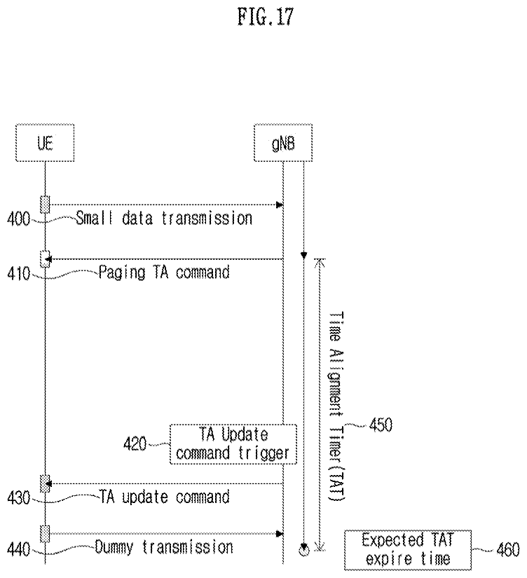

FIG. 17 is a diagram for explaining an example of an uplink synchronization maintenance operation for a terminal in an inactive state initiated by a base station to which the present disclosure can be applied.

The example of FIG. 17 corresponds to an example of a trigger condition of a base station in which a terminal in an inactive state performs uplink transmission (e.g., small data and/or dummy data transmission) to maintain uplink synchronization to the base station.

Unlike in the examples of FIG. 16, the terminal performs uplink transmission (e.g., small data and/or dummy data transmission) for maintaining uplink synchronization according to the determination of the terminal, in the example of FIG. According to a command of the base station, the terminal may perform uplink transmission (e.g., small data and/or dummy data transmission) for maintaining uplink synchronization to the base station.

FIG. 17 shows the operation of the terminal and the base station based on the TAT expiration time 460 expected in the base station.

For example, when a predetermined trigger condition is satisfied based on the expected TAT expiration time 460, the base station 420, the base station causes the terminal to transmit uplink for maintaining uplink synchronization (e.g. For example, a TA update command for performing small data and/or dummy data transmission) may be transmitted (430). Accordingly, the terminal may perform uplink transmission (e.g., small data and/or dummy data transmission) for maintaining uplink synchronization at the next available uplink transmission opportunity (440). Accordingly, the terminal may receive the TAC from the base station at the next available paging opportunity and restart the TAT.

The above-described TA update command corresponds to information instructing the UE that TA update is required, unlike the TAC. That is, when the terminal receives the TA update command, the terminal may perform uplink transmission (e.g., small data and/or dummy data transmission) for maintaining uplink synchronization at an uplink transmission opportunity to the base station, and transmit the TAC. If received, the TAT can be (re)started.

In addition, the TA update command may be transmitted to the terminal while the TAT expected by the base station operates (450). For example, when the terminal performs uplink transmission (e.g., small data and/or dummy data transmission) (400), the base station may transmit a paging message including the TAC to the terminal (410).

Accordingly, the base station may determine that the TAT is (re)started in the terminal, and may determine the TAT operation 450 time and the expected TAT expiration time 460 for the corresponding terminal.

Here, the predetermined trigger condition may be defined as a time spaced apart by a predetermined time before the TAT expires (i.e., a predetermined time remains until the TAT expiration time). Here, the predetermined time may be defined as the preset number of uplink transmission opportunities, the number of paging opportunities, a predetermined time interval, or a predetermined timer.

In addition, since the TAT has not yet expired at the time of determining whether the predetermined trigger condition is satisfied, an expected TAT expiration time may be applied. The expected expiration time of the TAT may be calculated as a time point by adding the length of time of the TAT from the time when the base station transmits the TAC to the terminal (or the time when the terminal is expected to (re)start the TAT by transmitting the TAC).

Here, the TA update command may be provided to the terminal through a short message or a paging message. Accordingly, the UE may monitor the CRC scrambled PDCCH with the P-RNTI at the paging opportunity, and check whether a TA update command is included in a short message or a paging message from the DCI of the PDCCH.

Tables 9 and 10 show examples of TA update commands through a short message or a paging message. Table 9 may correspond to a part of the DCI format shown in Table 4, and Table 8 may correspond to a part of the paging message format shown in Table 5

TABLE 9

| Field | Bits | Reference |
|---|---|---|
| Short | 2 | 00: Reserved |
| Message | | 01: Scheduling information only for Paging |
| Indicator | | 10: Short message |
| | | 11: Paging and Short message |
| | | 01: paging message |
| | | 10 or 11: Short message |
| Short | 8 | 1: SI modification |
| Message | | 2: ETWS and CMAS indication |
| | | 3-8: TA update command |

TABLE 10

| | |
|---|---|
| TA update command | BOOLEAN (TRUE or FALSE) |
| indicator | |
| pagingUE-Identity | I-RNTI |

In Table 9, when the value of the Short Message Indicator field is 01, a TA update command may be provided through a paging message, and when it is 10, a TA update command may be provided through a short message. When the value of the short message indicator field is 11, it may indicate that the TA update command is provided through paging or a short message. That is, when the value of the short message indicator field is 11, the base station performs paging or The TA update command may be provided through one of the short messages, and when the terminal receives the TA update command from any of the paging or short messages, an operation according to the TA update command (e.g., small data and/or dummy data transmission).

When the value of the Short Message Indicator field is 10 or 11, indicating that the TA update command is provided through a short message, one of the values that the Short Message field may have is the TA update. command can be given. For example, one of 3 to 8 among the values of the Short Message field may correspond to the TA update command.

When the value of the Short Message Indicator field is 01 or 11 indicating that the TA update command is provided through the paging message, a field as shown in Table 10 may be included in the paging message. That is, the paging message may additionally include a TA Update Command field, and when the value of the corresponding field is 0, TA update is not indicated, and when it is 1, TA update may be indicated. Also, the pagingUE-Identity field in the paging message may be set to I-RNTI.

Therefore, the value of the short message indicator (Short Message Indicator) is 10 or 11, and the terminal receiving the PDCCH DCI in which the value of the short message (Short Message) field is set to any one of 3 to 8 is the next uplink transmission opportunity Uplink transmission (e.g., small data and/or dummy data transmission) for maintaining uplink synchronization may be performed.

Alternatively, the terminal receives the PDCCH DCI in which the value of the Short Message Indicator is set to 01 or 11, and the TA update command in the paging message received according to the scheduling information of the paging message indicated by the DCI (When receiving the paging message in which the value of the TA Update Command) field is set to 1, the terminal performs uplink transmission (e.g., small data and/or dummy data transmission) for maintaining uplink synchronization at the next uplink transmission opportunity. can be done

Hereinafter, specific operations of the terminal and the base station based on the above-described embodiments 1-1 and 1-2 will be described.

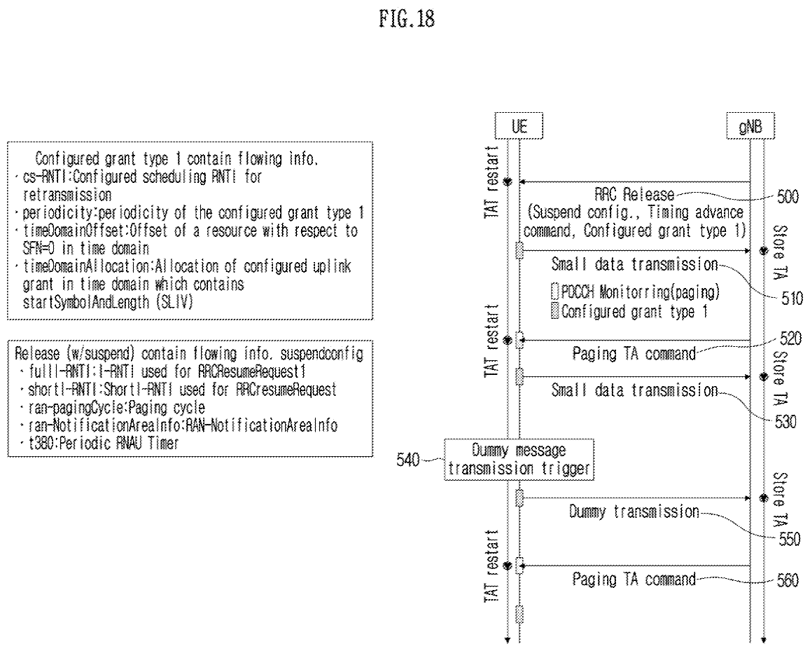

FIG. 18 is a diagram for explaining an additional example of an uplink synchronization maintenance operation of a terminal in an inactive state to which the present disclosure can be applied.

In the example of FIG. 18, the terminal may receive an RRC release message from the base station in the RRC connection state (500). When the RRC release message includes a suspend config, the UE may transition to an inactive state. The stop setting may include full I-RNTI, short I-RNTI, RAN-paging cycle, RAN-notification area information, t380, and the like. The full I-RNTI may be a terminal identifier used for the RRC resume request (RRCResumeRequest1), and the short I-RNTI may correspond to a terminal identifier used for the RRC resume request (RRCResumeRequest). The RAN-paging cycle may indicate a paging cycle or period. RAN-Notification region information may include information on RNA. In addition, t380 may correspond to a set value for the periodic RAN update timer T380.

In addition, the RRC release message may further include uplink transmission resource configuration information of the configured grant type 1 scheme. The UE may determine and activate a resource for periodic uplink transmission by applying the configured grant type 1 configuration information. For example, the configured grant type 1 configuration information may include CS-RNTI, period, time domain offset, time domain allocation information, and the like. The CS-RNTI may correspond to an identifier of a terminal for uplink transmission/retransmission. The period may correspond to a time interval in which uplink transmission resources are allocated. The time domain offset may correspond to an offset of an uplink transmission resource position based on a time when a system frame number (SFN)=0 in the time domain. The time domain allocation may include a Start and Length Indicator Value (SLIV) indicating a start symbol and a length of an uplink transmission resource.

In addition, the RRC release message may further include TAC. Accordingly, the UE may (re)start the TAT by applying the TAC.

Alternatively, unlike the example of FIG. 18, the TAC may be provided to the terminal before receiving the RRC release message, so that a valid TAT in the terminal may be in operation. Alternatively, the uplink transmission resource of the grant type 1 configured to the terminal may be configured and activated before receiving the RRC release message.

The terminal in the inactive state transmits small data 510 and 530 if there is small data to be transmitted in the uplink transmission opportunity according to the configured grant type 1, and if not, can skip the uplink transmission opportunity.

The terminal in the inactive state may receive a paging message through PDCCH monitoring at a paging opportunity according to the paging period (520). If the paging message includes the TAC, the UE may apply the TAC and restart the TAT.

The terminal in the inactive state may determine whether a predetermined trigger condition is satisfied (540). For example, the predetermined trigger condition is one of a time when a predetermined time has elapsed from the start of the TAT, a time when a predetermined time remains until the expiration of the TAT, after the T380 timer expires, or after receiving a TA update command from the base station or it may be determined by a combination of two or more.

If a predetermined trigger condition is satisfied, in the next available uplink transmission resource according to the configured grant type 1, the terminal transmits uplink for uplink synchronization maintenance (e.g., small data and/or dummy data) transmit) may be performed (550).

The base station may store the TA based on the time point at which uplink transmission is received from the terminal in an inactive state. The base station may generate a TAC based on the most recently stored TA and transmit it to the terminal (560).

The time when the base station transmits the TAC to the terminal may be the next available paging opportunity of the terminal, or may be determined based on the expected expiration time of the TAT. For example, the base station may transmit the TAC to the terminal at an available paging opportunity immediately after determining the TAC, or may transmit the determined TAC to a subsequent paging opportunity. More specifically, after determining the TAC, the base station may transmit the TAC to the terminal at a paging opportunity in which the remaining time until the expected TAT expiration time is less than or equal to a predetermined time. For example, if the time remaining until the expected TAT expiration time is a part of the TAT length (e.g., TAT/2, TAT/3, TAT/4, . . . ), paging opportunity belonging to the remaining time interval (If a plurality of paging opportunities belong to the remaining time interval, one of them, or the earliest or the latest paging opportunity), the TAC may be transmitted to the UE. Here, the time remaining until the TAT expiration time related to the TAC transmission time may be predefined or may be selectively determined by the base station.

The terminal receiving 560 the TAC from the base station may restart the TAT by applying the TAC.

Here, the paging period of the terminal may be uniquely set for each terminal. For example, the paging period of the terminal may be set to a length shorter than the TAT time.

Also, the allocation period of the uplink transmission resource (e.g., the transmission resource according to the configured grant type 1) preset to the terminal may be set to a length shorter than the TAT time.

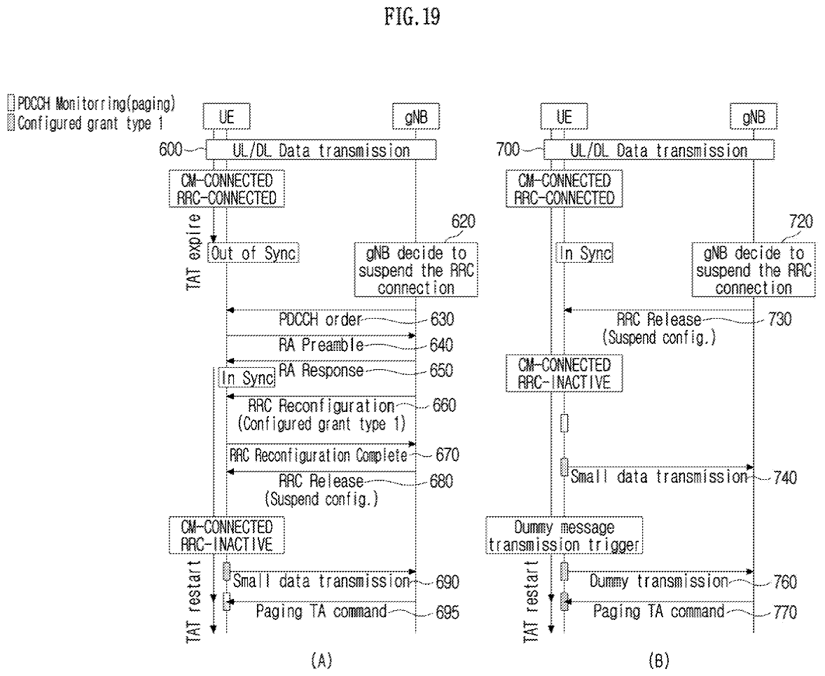

FIG. 19 is a diagram for explaining an additional example of an uplink synchronization maintenance operation of a terminal in an inactive state to which the present disclosure can be applied.

In the example of FIG. 19, the operation of the terminal and the base station according to the uplink synchronization state of the terminal (e.g., in-sync or out of sync state) and the presence or absence of a set grant resource indicates

FIG. 19 (a) shows the operation of the terminal in the inactive state when the TAT expires in the RRC connected state, becomes an out of sync state, and the configured grant resource is not allocated.

For example, the terminal may perform uplink/downlink data transmission/reception with the base station in the RRC connection state (600). The base station may determine to stop the RRC connection to the corresponding terminal (620).

When the TAT expires in the RRC connection state, the terminal may be in an out of sync state. In this case, the base station may transmit a PDCCH order to the terminal for which uplink synchronization is not maintained (630). The PDCCH order may include information according to DCI format 1A and may instruct the UE to perform a random access procedure.

The UE may transmit a random access preamble to the base station with reference to information included in DCI format 1A of the PDCCH scrambled with C-RNTI (640).

The base station may generate a TAC based on the time when the random access preamble is received from the terminal, include it in the random access response, and transmit it to the terminal (650). Accordingly, the UE may enter the in-sync state by applying the TAC and starting the TAT.

Next, the base station may allocate a periodic uplink transmission resource to the terminal. For example, the base station may include the configured grant type 1 configuration information in the RRC message and transmit it to the terminal (660). For example, the grant type 1 configuration information configured in the RRC reconfiguration message may be included. The UE may transmit an RRC reconfiguration complete message in response to the RRC reconfiguration message (670). Accordingly, the UE may be in a state in which TAT is operating and resources to be used for future uplink transmission are allocated and activated.

The terminal may receive an RRC release message including a stop setting from the base station (680). Accordingly, the UE may transition from the RRC connected state to the inactive state.

The terminal may transmit small data in an inactive state by using the periodic uplink transmission resource 660 allocated from the base station in the RRC connection state (690).

The base station receiving the uplink transmission from the terminal in an inactive state may generate a TAC and transmit the TAC to the terminal's paging opportunity (695). Upon receiving the TAC, the UE may restart the TAT by applying the TAC.

FIG. 19(b) shows the operation of the terminal in the inactive state when the TAT is operating in the in-sync state in the terminal in the RRC connection state and the configured grant resource is previously allocated.

For example, the terminal may perform uplink/downlink data transmission/reception with the base station in the RRC connection state (700). While the TAT is in operation (i.e., in an in-sync state), the base station may determine to stop the RRC connection to the corresponding terminal (720).

The terminal may receive an RRC release message including a stop configuration from the base station (730). Accordingly, the UE may transition from the RRC connected state to the inactive state. Before the terminal transitions to the inactive state, the base station may allocate a periodic uplink transmission resource to the terminal.

For example, the base station may transmit the configured grant type 1 configuration information to the terminal through the RRC message prior to the RRC release message 730 or may be included in the RRC release message 730 and transmitted to the terminal. In addition, the RRC release message may further include a TAC.

The terminal may transmit small data in an inactive state by using the periodic uplink transmission resource allocated from the base station (740).

The terminal in the inactive state may determine whether a predetermined trigger condition is satisfied (750). For example, the predetermined trigger condition is one of a time when a predetermined time has elapsed from the start of the TAT, a time when a predetermined time remains until the expiration of the TAT, after the T380 timer expires, or after receiving a TA update command from the base station or it may be determined by a combination of two or more.

When a predetermined trigger condition is satisfied, the terminal may perform uplink transmission (e.g., small data and/or dummy data transmission) for maintaining uplink synchronization in the next available uplink transmission resource. (760).

The base station receiving the uplink transmission from the terminal in an inactive state may generate a TAC and transmit the TAC to the terminal's paging opportunity (770). Upon receiving the TAC, the UE may restart the TAT by applying the TAC.

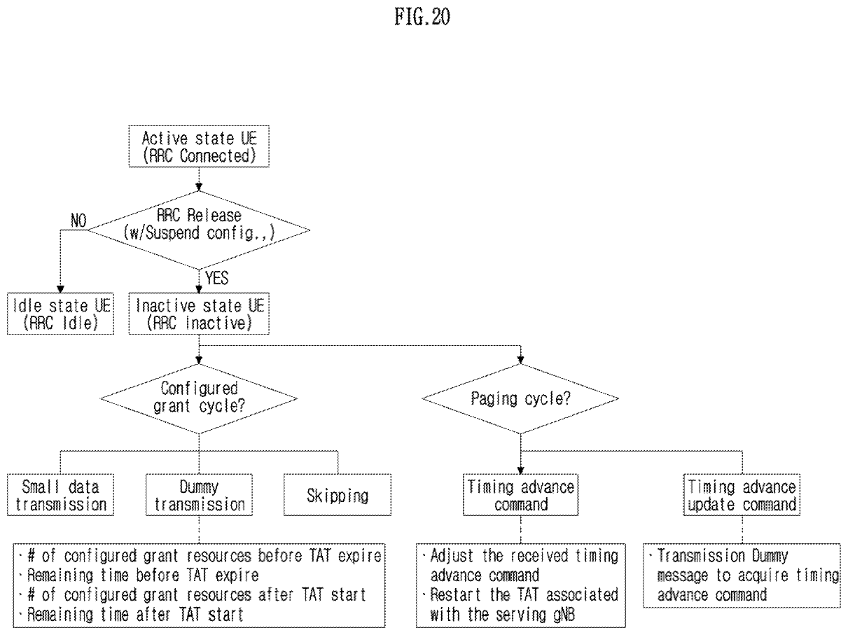

FIG. 20 is a diagram for explaining an embodiment of a terminal operation to which the present disclosure can be applied.

The UE in the RRC connection state may determine whether the RRC release message includes suspend configuration, TAC, and configured grant type 1 configuration information.

If the stop setting is not included, the terminal may transition to the idle state.

When the stop setting is included, the terminal may transition to an inactive state. In addition, the UE stores and applies information (e.g., I-RNTI, paging cycle, periodic RNA update timer, coordinated cell information (CoordinatedCellInfo), etc.) included in the RRC release message including the stop setting.

If the TAC is included, the terminal may apply the TAC and (re)start the TAT.

When the configured grant type 1 configuration information is included, the terminal may determine a period of an uplink transmission resource according to the configured grant type 1 scheme, time-frequency resource allocation, and the like.

With respect to the uplink transmission resource corresponding to the configured grant period, the UE may determine whether small data exists in the MAC entity buffer.

If the small data exists, the terminal may transmit the small data and restart the T380 timer.

If there is no small data transmission, the terminal may determine whether dummy data transmission is triggered. For example, the trigger condition is whether the number of set grant resources remaining before TAT expiration is less than or equal to a set value, whether the time remaining until TAT expiration is less than or equal to a set value, and whether the number of used and unused grant resources after TAT start is It may include one or more of whether it is more than a set value, whether the T380 timer has expired, or whether a TA update command has been received in a previous paging cycle. When the dummy data transmission is triggered, the UE may transmit the dummy data in the configured grant resource and restart the T380 timer.

When small data transmission does not exist and dummy data transmission is not triggered, the UE may skip uplink transmission in the configured grant resource.

On the other hand, the terminal may determine whether it corresponds to the paging period.

If it corresponds to the paging period, the terminal may monitor the CRC scrambled PDCCH with the P-RNTI in the paging opportunity and receive the DCI.

Among the information included in DCI, the value of the short message field is checked when the value of the Short Message Indicator field is 10 or 11, and the value of the short message field is 3 to 8 indicating the TA update command. In one of these cases, the terminal may prepare for uplink transmission in the configured grant resource.

Check the value of the TA update command field in the paging message when the value of the Short Message Indicator field is 01 among the information included in the DCI, and when the value of the TA update command field is 1, the terminal may prepare for uplink transmission in the configured grant resource.

In uplink transmission according to the TA update command, the UE transmits small data in the next configured grant resource when small data exists in the MAC entity buffer until the next configured grant resource, and when small data does not exist Dummy data may be transmitted from the next configured grant resource.

If there is no TA update command, the UE may skip uplink transmission in the next configured grant resource.

When the TAC is included in the paging message, the terminal may apply the TAC and restart the TAT.

### Embodiment 2

This embodiment relates to a method for maintaining uplink synchronization for a cell other than a serving cell by a terminal in an inactive state.

For example, the terminal in an inactive state may perform uplink synchronization for a new cell in a cell reselection process. That is, the terminal transitioned to the inactive state in the last serving cell (or source cell) may perform initial uplink synchronization in the target cell.

The terminal in the inactive state may perform camping with the selected target cell when a cell reselection condition occurs like the terminal in the idle state. If the target cell belongs to the same RNA as the last serving base station, the UE does not perform the RNA update, and if the target cell belongs to a different RNA, the RNA update may be performed.

When the uplink transmission of the terminal is not supported in the inactive state, there is no need for the terminal to acquire uplink synchronization (or TA) from the target cell. However, in order to support the uplink transmission of the terminal in the inactive state, the terminal needs to acquire or maintain uplink synchronization (or TA) in the target cell, and there is no specific procedure for this.

Accordingly, in this embodiment, a method for obtaining or maintaining uplink synchronization for a target cell by a terminal in an inactive state will be described. For example, depending on whether the target cell is a coordinated cell with the serving cell, the uplink synchronization process of the terminal in the inactive state may be defined differently.

For example, when the UE in the RRC connection state receives the RRC release message including the stop setting from the serving cell, it may transition to the inactive state. Here, the RRC release message including the stop setting includes information available to the terminal in an inactive state (e.g., I-RNTI, paging cycle, periodic RNA update timer, coordinated cell information (CoordinatedCellInfo), etc.).

When the target cell is included in the coordinated cell information (CoordinatedCellInfo) among the information possessed by the terminal in the cell reselection process of the terminal in the inactive state, the periodic uplink transmission resource allocated from the serving cell (For example, uplink transmission (e.g., small data and/or dummy data transmission) for maintaining uplink synchronization may be performed using the configured grant type 1 configuration information).

Table 11 shows an example of coordinated cell information. Although Table 11 shows information on two cells by way of example, information on two or more cells may be included in coordinated cell information.

TABLE 11
Coordinated Cell Information

| PCIs | Uplink timing offset |
|---|---|
| 1 | BIT STRING 1 |
| 2 | BIT STRING 2 |

As in the example of Table 11, the coordinated cell information may include an uplink timing offset value according to a cell identifier (e.g., a physical cell identifier (PCI)). The timing offset is the last serving It may correspond to a difference value between the uplink transmission timing of a cell and the uplink transmission timing of another cell, for example, for a cell corresponding to PCI index 1, an uplink timing offset value expressed by bit string index 1 is applied, and an uplink timing offset value expressed by bit string index 2 may be applied to a cell corresponding to PCI index 2. Accordingly, an uplink timing offset between coordinated cells may be derived. A preset periodic uplink transmission resource (e.g., an uplink transmission resource according to the configured grant type 1) may be valid for other cell(s) coordinated with the serving cell. Cells included in the cell can determine the uplink transmission resource of the configured grant type 1. More specifically, the cells belonging to the coordinated cell use the slot number and SFN synchronized with the last serving cell (or source cell). to allocate the uplink transmission resource of the configured grant type 1. Accordingly, the configured grant information provided in any one of a plurality of cells belonging to the cell coordinated by the terminal in an inactive state can be used in the remaining cells as well.

In addition, an uplink timing offset may be applied between the serving cell and another cell. That is, at a timing in which the timing offset of another cell is applied to the timing of the uplink transmission resource allocated in the serving cell, uplink transmission to the other cell may be allowed.

Accordingly, when the target cell selected by the terminal in the cell reselection process is included in the coordinate cell information provided by the last serving cell, the terminal based on the uplink timing offset value for the target cell, the last serving cell Uplink transmission may be performed to the target cell using the periodic uplink transmission resource allocated from target cell.

When an uplink transmission for maintaining uplink synchronization (e.g., small data and/or dummy data transmission) is received from a terminal in an inactive state, the target cell requests terminal context information to the base station of the last serving cell. can Accordingly, the target cell may transmit the TAC according to the paging period of the terminal in the inactive state.

In the case of using the uplink timing offset of the coordinated cell information in this way, since the UE in an inactive state can omit the random access procedure in the cell reselection process, the signaling overhead of the cell reselection process is reduced and can acquire or maintain uplink synchronization for target cell.

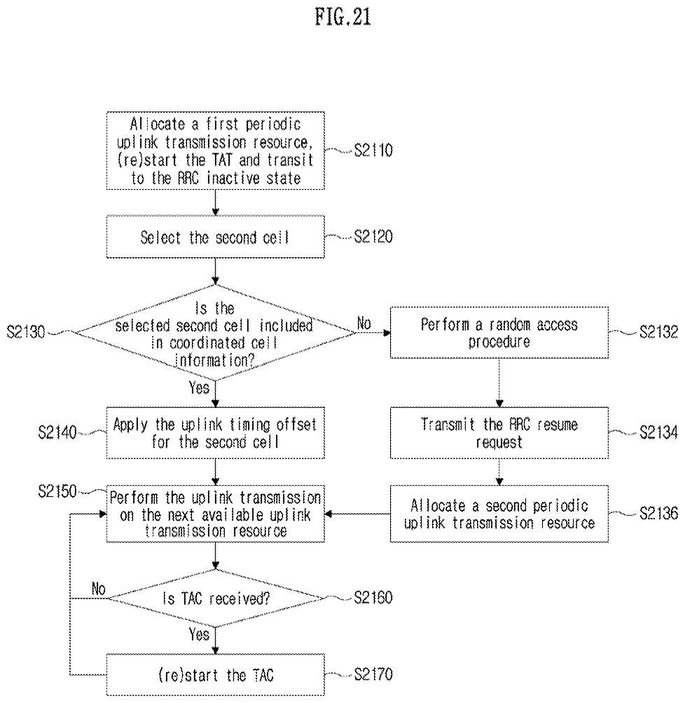

FIG. 21 is a diagram for explaining an uplink synchronization operation of a terminal in a cell reselection process to which the present disclosure is applied.

In the example of FIG. 21, the first cell corresponds to the last serving cell of the terminal, and the second cell corresponds to a new target cell selected by the terminal in the cell reselection process.

In step S2110, the terminal may be allocated a first periodic uplink transmission resource in the first cell. For example, the first cell may be a serving cell of the terminal, and the first periodic uplink transmission resource may correspond to an uplink transmission resource according to the configured grant type 1 allocated by the first cell. Also, the UE may (re)start TAT. For example, the UE may receive and apply the TAC through an RRC message or a paging message provided from the first cell, and (re)start the TAT. In addition, according to the configuration from the first cell, the UE may transition from the RRC connected state to the inactive state.

In step S2120, the terminal in the inactive state may select the second cell as the target cell in the cell reselection process.

In step S2130, the terminal may determine whether the second cell belongs to the cell coordinated with the first cell. For example, when the second cell is included in the coordinated cell information provided through the RRC release message from the first cell to the UE, based on this, the uplink timing offset for the second cell may be applied in step S2140. have.

In step S2150, the terminal determines the next available uplink transmission resource for the second cell by applying the uplink timing offset for the second cell to the first periodic uplink transmission resource allocated by the first cell. That is, even if a separate periodic uplink transmission resource is not allocated from the second cell, based on the first periodic uplink transmission resource possessed by the UE and the uplink timing offset for the second cell, the second cell is allowed Uplink transmission resources may be determined.

The uplink transmission in step S2150 may include small data and/or dummy data. Specifically, in the uplink transmission of step S2150, determination of the existence of small data in steps S1430 to S1436, S1440, and S1450 of FIG. 14, determination of whether a trigger condition related to transmission of dummy data is satisfied, a skip operation, etc. to the second cell Since it includes performing with respect to, a redundant description will be omitted.

In step S2160, the UE may determine whether the TAC is received from the second cell. The TAC may be received through a paging message. When the TAC is received, the UE may apply it and (re)start the TAT in step S2170. If the TAC is not received, in step S2150, the UE may perform uplink transmission to the second cell while the previously started TAT is in operation.

Meanwhile, if the second cell does not belong to the cell coordinated with the first cell in step S2130, the terminal may perform a random access procedure for the second cell in step S2132. For example, the UE may transmit a random access preamble to the second cell and receive a random access response including a TAC from the second cell. That is, the UE receives the TAC from the second cell and applies it to the second cell by transmitting the preamble at a random access opportunity determined by system information of the second cell, regardless of uplink synchronization for the first cell. It is possible to acquire uplink synchronization for (i.e., start TAT).

In step S2134, the UE may transmit an RRC resume request message to the second cell. For example, the RRC resumption request may be transmitted based on scheduling information (e.g., an uplink grant for Msg3 transmission) included in the random access response.

In step S2136, a second periodic uplink transmission resource may be allocated by the second cell. For example, the second periodic uplink transmission resource may be included in the RRC release message including the stop setting for the terminal. The second periodic uplink transmission resource may correspond to an uplink transmission resource according to the configured grant type 1 allocated by the second cell. Accordingly, the terminal is in an inactive state in the second cell, and can perform uplink transmission in the next available uplink transmission resource (i.e., the second periodic uplink transmission resource) in step S2150.

Hereinafter, specific embodiments of the present disclosure related to the example of FIG. 21 will be described.

### Embodiment 2-1

This embodiment relates to an uplink synchronization operation for the second cell of the terminal when the second cell does not belong to the cell coordinated with the first cell. This embodiment may also be applied to a case in which the UE performs uplink synchronization in the second cell in a state where the TAT started in the first cell has expired.

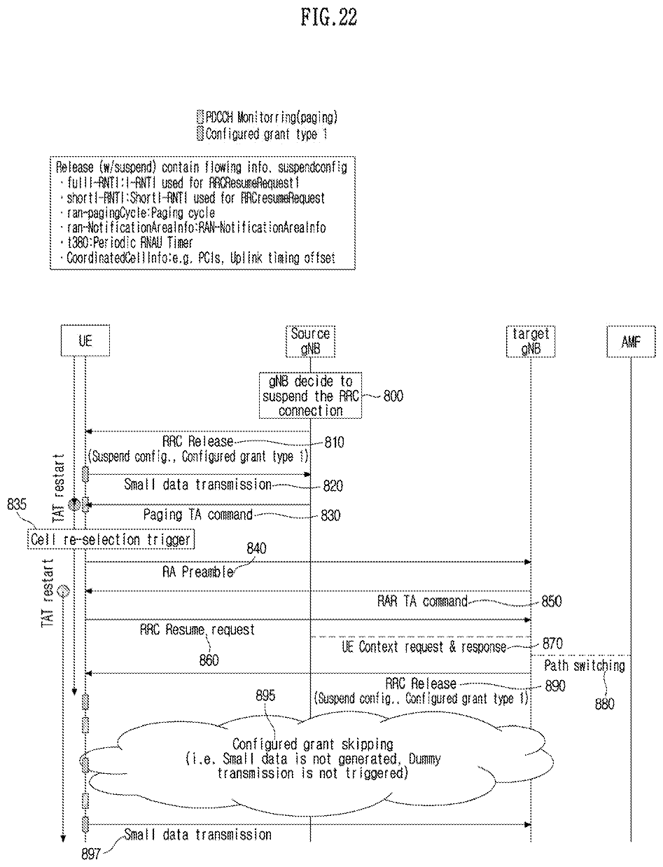

FIG. 22 is a diagram for explaining an embodiment of operations of a terminal and a base station for uplink synchronization in a cell reselection process to which the present disclosure can be applied.

The first cell (or source base station) determines to stop the RRC connection of the terminal (800), the first cell may transmit an RRC release message to the terminal (810). For example, the RRC release message may include a stop configuration, a first periodic uplink transmission resource (e.g., first configured grant type 1 configuration information), coordinated cell information, and the like. Accordingly, the terminal may transition to the inactive state, and thereafter may transmit small data using the first configured grant (820). Upon receiving the uplink transmission from the terminal in the inactive state, the first cell may transmit a paging message including the TAC to the corresponding terminal (830). Accordingly, the terminal may restart the first TAT.

Cell reselection may be triggered in a terminal in an inactive state (835). The UE may select the second cell as the target cell, and the second cell may not correspond to a cell coordinated with the first cell. For example, the UE may determine whether to include the coordinated cell of the second cell based on the coordinated cell information included in the RRC release message 810.

In this case, the UE may transmit a random access preamble to the second cell (840). In response, the second cell may transmit a random access response including the TAC and Msg3 scheduling information to the UE. The uplink synchronization of the second cell is separate from the uplink synchronization of the first cell, and the second TAT operated by the TAC from the second cell is separate from the first TAT operated by the TAC from the first cell. can be started Since no additional TAC is provided from the first cell after cell reselection, the first TAT may expire.

The UE may transmit an RRC resume request message to the second cell using the Msg3 scheduling information received through the random access response. When receiving the RRC resume request including the I-RNTI, the second cell may request terminal context information from the base station (i.e., the source base station) of the last serving cell (870). Also, the second cell may notify the AMF of path switching to change the path between the first cell and the AMF to the second cell (880). Thereafter, the second cell may transmit an RRC release message including a second periodic uplink transmission resource (e.g., second configured grant type 1 configuration information) and a stop configuration for the inactive terminal to the terminal (890).

The terminal may transmit small data and/or dummy data to the second cell by using the second configured grant allocated from the second cell (897). If the small data does not exist or the dummy data transmission trigger condition is not satisfied, the uplink transmission opportunity according to the second configured grant may be skipped (895). The trigger condition related to the dummy data transmission may be similarly applied to the above-described first embodiment.

### Embodiment 2-2

This embodiment relates to an uplink synchronization operation for the second cell of the terminal when the second cell belongs to a cell coordinated with the first cell.

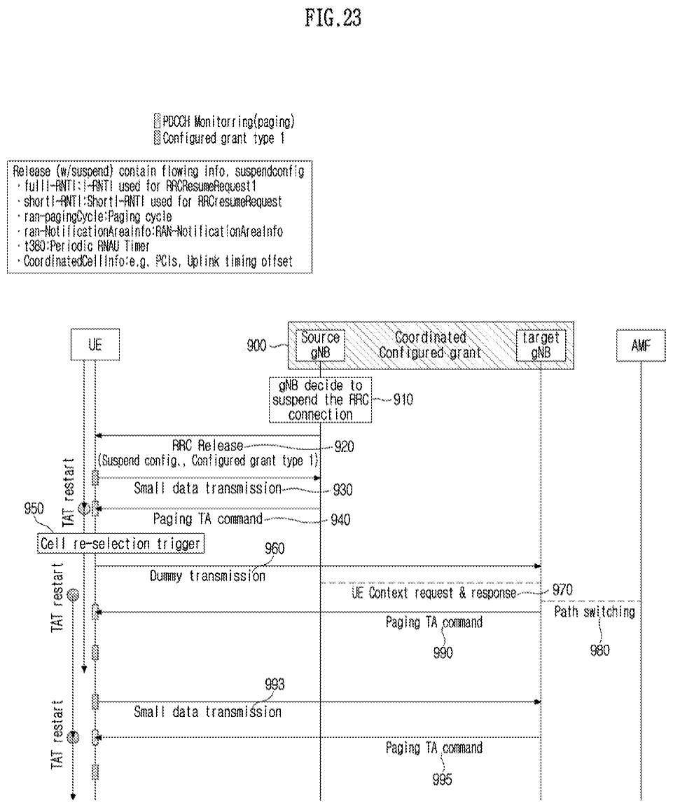

FIG. 23 is a diagram for explaining an additional embodiment of operations of a terminal and a base station for uplink synchronization in a cell reselection process to which the present disclosure can be applied.

Since steps 910 to 950 of FIG. 23 correspond to steps 800 to 835 of FIG. 22, overlapping descriptions are omitted.

In the example of FIG. 23, unlike the example of FIG. 22, the second cell selected by the UE triggering cell reselection may correspond to a cell coordinated with the first cell. For example, the UE may determine whether to include the coordinated cell of the second cell based on the coordinated cell information included in the RRC release message 920.

When the second cell belongs to the coordinated cell, the terminal in the inactive state sets the uplink timing offset indicated in the coordinated cell information to the first periodic uplink transmission resource (e.g., provided by the first cell). Uplink transmission for the second cell may be performed by applying the configured grant type 1 configuration information). That is, the coordinated cell information may correspond to information indicating whether the grant information set by the first cell can be used as it is in the second cell.

Accordingly, in the first periodic uplink transmission resource (or the uplink transmission resource according to the configured grant type 1 configuration) allocated from the source cell (i.e., the first cell) before the terminal cell reselection is triggered, by applying the uplink timing offset for the target cell (i.e., the second cell), periodic uplink transmission may be performed in the target cell (i.e., the second cell). That is, even if the terminal does not acquire uplink synchronization through the random access procedure for the second cell, based on the uplink timing offset in the second cell and the first configured grant information, uplink transmission available in the second cell Resources or transmission opportunities may be determined.

The UE may transmit small data and/or dummy data from the second cell to the second cell in the next available uplink transmission resource (960, 993). If the small data does not exist or the dummy data transmission trigger condition is not satisfied, the uplink transmission opportunity according to the second configured grant may be skipped. The trigger condition related to the dummy data transmission may be similarly applied to the above-described first embodiment.

When the terminal transmits dummy data to the second cell (960), the second cell may request terminal context information from the first cell (970). Also, the second cell may notify the AMF of path switching to change the path between the first cell and the AMF to the second cell (980).

When the second cell receives dummy data from the terminal (960), the second cell may transmit a paging message including the TAC to the terminal (990). In addition, when the second cell receives the small data from the terminal (993), the second cell may transmit a paging message including the TAC to the terminal (995).

The terminal receiving the TAC from the second cell (990, 995) may restart the TAT. Here, the periodic uplink transmission resource (or configured grant type 1 configuration information) allocated in the first cell is effectively usable by applying the uplink timing offset without separate configuration in the second cell, but the TAT is the first The cell and the second cell may be set in common or may be set separately. For example, the UE may operate the same TAT in the first cell and the second cell. That is, the TAT (re)started by the TAC from the first cell may be restarted by the TAC from the second cell. Alternatively, the UE may operate separate TATs in the first cell and the second cell, respectively. That is, a second TAT operated by the TAC from the second cell, which is distinct from the first TAT operated by the TAC from the first cell, may be started. Since no additional TAC is provided from the first cell after cell reselection, the first TAT may expire.

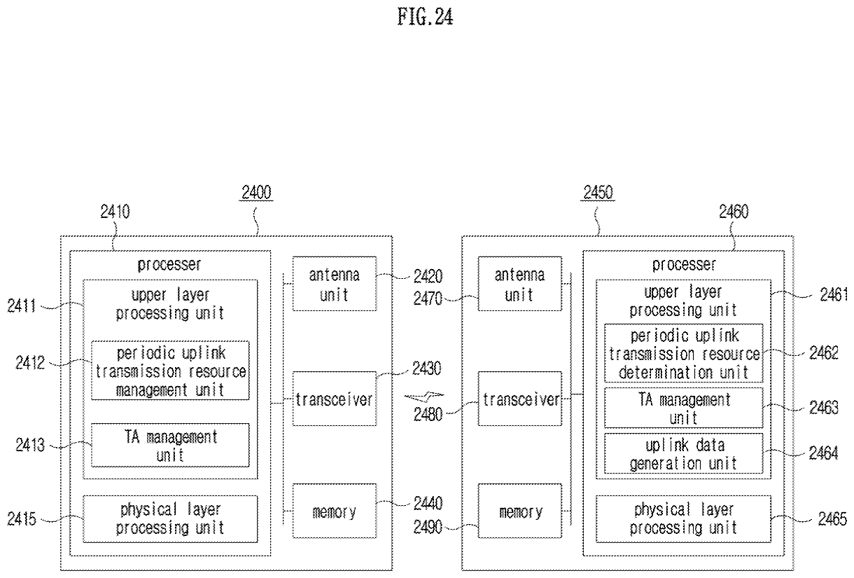

FIG. 24 is a diagram showing the configuration of a base station apparatus and a terminal apparatus according to the present disclosure.

The base station device 2400 may include a processor 2410, an antenna unit 2420, a transceiver 2430, and a memory 2440.

The processor 2410 performs baseband-related signal processing, and may include an upper layer processing unit 2411 and a physical layer processing unit 2415. The higher layer processing unit 2411 may process operations of the MAC layer, the RRC layer, or higher layers. The physical layer processing unit 2415 may perform PHY layer operations (e.g., uplink reception signal processing, downlink transmission signal processing, etc.). The processor 2410 may control the overall operation of the base station device 2400 in addition to performing baseband-related signal processing.

The antenna unit 2420 may include one or more physical antennas, and when including a plurality of antennas, may support MIMO transmission/reception. The transceiver 2430 may include an RF transmitter and an RF receiver. The memory 2440 may store information processed by the processor 2410, software related to the operation of the base station device 2400, an operating system, an application, and the like, and may include components such as a buffer.

The processor 2410 of the base station apparatus 2400 may be set to implement the operation of the base station in the embodiments described in the present invention.

For example, the upper layer processing unit 2411 of the processor 2410 of the base station device 2400 may include a periodic uplink transmission resource management unit 2412 and a TA management unit 2413.

The periodic uplink transmission resource management unit 2412 is configured to configure and information on a periodic uplink transmission resource (e.g., configured grant type 1) for the terminal device 2450 and information indicating activation or deactivation thereof may be generated and provided to the terminal device 2450.

The TA management unit 2413 determines whether the TAT for the terminal device 2450 is operating or expires, and generates a TAC based on the time point when the uplink transmission from the terminal device 2450 is received, and the terminal device 2450) can be provided to In particular, when small data and/or dummy data are received from a terminal in an inactive state on a periodic uplink transmission resource, the TA manager 2413 may generate a TAC and provide it to the terminal.

In addition, when a trigger condition (e.g., a condition related to the time remaining until the TAT expires) in the uplink synchronization maintenance operation initiated by the base station is satisfied, the TA manager 2413 is a TA update command may be generated and provided to the terminal device 2450.

In addition, the upper layer processing unit 2411 generates an RRC message for setting the RRC connection, inactivity, and idle state for the terminal and provides it to the terminal device 2450, and processes messages such as RRC resume request from the terminal can do.

The physical layer processing unit 2415 of the processor 2410 of the base station device 2400 is an RRC message transmitted from the upper layer processing unit 2411, periodic uplink transmission resource setting information and activation/deactivation information, TAC information, TA update command or the like may be transmitted to the terminal device 2450. In addition, the physical layer processing unit 2415 may transmit uplink data (e.g., small data and/or dummy data), an RRC message, etc. received from the terminal device 2450 to the uplink processing unit 2411.

The terminal device 2450 may include a processor 2460, an antenna unit 2470, a transceiver 2480, and a memory 2490.

The processor 2460 performs baseband-related signal processing, and may include an upper layer processing unit 2461 and a physical layer processing unit 2465. The higher layer processing unit 2461 may process the operation of the MAC layer, the RRC layer, or higher layers. The physical layer processing unit 2465 may perform PHY layer operations (e.g., downlink reception signal processing, uplink transmission signal processing, etc.). The processor 2460 may control the overall operation of the terminal device 2460 in addition to performing baseband-related signal processing.

The antenna unit 2470 may include one or more physical antennas, and when including a plurality of antennas, may support MIMO transmission/reception. The transceiver 2480 may include an RF transmitter and an RF receiver. The memory 2490 may store information processed by the processor 2460, software related to the operation of the terminal device 2450, an operating system, an application, and the like, and may include components such as a buffer.

The processor 2460 of the terminal device 2450 may be configured to implement the operation of the terminal in the embodiments described in the present invention.

For example, the upper layer processing unit 2461 of the processor 2460 of the terminal device 2450 includes the periodic uplink transmission resource determination unit 2462, the TA management unit 2463, and the uplink data generation unit 2464.

The periodic uplink transmission resource determiner 2462 performs configuration and information on the periodic uplink transmission resource (e.g., configured grant type 1) provided from the base station device 2400 and activation or deactivation thereof. It is possible to receive and apply the indicated information.

The TA manager 2463 may (re)start the TAT based on the TAC provided from the base station device 2400, and determine whether the TAT operation or expiration.

In addition, the TA manager 2463 triggers a trigger condition in an uplink synchronization maintenance operation initiated by a terminal in an inactive state (e.g., a condition related to an elapsed time after the TAT starts, until the TAT expires) When one or more of a condition related to the remaining time, a condition related to expiration of the T380 timer, or a condition related to receiving a TA update command from the base station) is satisfied, uplink data (e.g., small data and/or dummy data) can trigger the transmission of

The uplink data generation unit 2464 may generate data to be transmitted to the base station device 2400 and transmit it to the physical layer processing unit 2465. In particular, when a predetermined trigger condition is satisfied in the terminal device 2450 in an inactive state, the uplink data generator 2464 may generate small data and/or dummy data to be transmitted on a periodic uplink transmission resource.

In addition, the upper layer processing unit 2461 may process the RRC message for setting the RRC connection, inactivity, and idle state from the base station, and generate a message such as an RRC resume request to be transmitted to the base station.

The physical layer processing unit 2465 of the processor 2460 of the terminal device 2450, the RRC message and uplink data (e.g., small data and/or dummy data) transmitted from the upper layer processing unit 2461 and the like may be transmitted to the base station device 2400. In addition, the physical layer processing unit 2465 may transmit the RRC message received from the base station device 2400, periodic uplink transmission resource setting information and activation/deactivation information, TAC information, TA update command, etc. to the upper layer processing unit 2461.

In the operations of the base station device 2400 and the terminal device 2450, the descriptions for the base station and the terminal in the examples of the present invention may be equally applied, and overlapping descriptions will be omitted.

The exemplary methods of the present disclosure are expressed as a series of operations for clarity of description, but this is not intended to limit the order in which the steps are performed, and if necessary, each step may be performed simultaneously or in a different order. In order to implement the method according to the present disclosure, other steps may be included in addition to the illustrated steps, other steps may be included except some steps, or additional other steps may be included except some steps.

The various embodiments of the present disclosure do not list all possible combinations in detail, but are intended to illustrate representative aspects of the present disclosure, and some or all of the items described in the various embodiments may be independently applied or two or more It can also be applied in combination.

In addition, various embodiments of the present disclosure may be implemented by hardware, firmware, software, or a combination thereof. For implementation by hardware, one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), general purpose It may be implemented by a processor (general processor), a controller, a microcontroller, a microprocessor, and the like.

The scope of the present disclosure is software or machine-executable instructions (e.g., operating system, application, firmware, program, etc.) that cause operation according to the method of various embodiments to be executed on a device or computer, and Such software or instructions include a non-transitory computer-readable medium that is stored and executable on an apparatus or computer. Instructions that can be used to program a processing system to perform features described in this disclosure may be stored on/in a storage medium or computer-readable storage medium, and can be viewed using a computer program product including such storage medium. Features described in the disclosure may be implemented. The storage medium may include, but is not limited to, high-speed random access memory such as DRAM, SRAM, DDR RAM or other random access solid state memory device, one or more magnetic disk storage devices, optical disk storage devices, flash memory devices, or may include non-volatile memory, such as other non-volatile solid state storage devices. The memory optionally includes one or more storage devices located remotely from the processor(s). The memory or alternatively the non-volatile memory device(s) within the memory includes a non-transitory computer-readable storage medium. Features described in this disclosure may be stored on any one of the machine readable media to control hardware of a processing system, and cause the processing system to interact with other mechanisms that utilize results according to embodiments of the present disclosure. It may be incorporated into software and/or firmware. Such software or firmware may include, but is not limited to, application code, device drivers, operating systems, and execution environments/containers.

### INDUSTRIAL APPLICABILITY

Examples of the present disclosure may be applied to various wireless communication systems.

What is claimed is:

1. A method for uplink synchronization of a terminal in an inactive state in a wireless communication system, the method comprising:
receiving configured grant configuration information from the base station;
starting a time alignment timer (TAT) by receiving a timing advance command (TAC) from the base station;
transitioning to an inactive state by receiving a RRC (Radio Resource Control) release message including a suspend configuration from the base station;
in the inactive state, receiving an additional TAC from the base station and restarting the TAT, uplink synchronization method.
